(19) United States
(12) Patent Application Publication
(10) Pub. No.: US 2026/0320426 A1
(43) Pub. Date: Oct. 15, 2026

(54) Knowledge-Augmented Artificial Intelligence Operations

(71) Applicant: Marion Dale Skeen, Menlo Park, CA (US)

(72) Inventor: Marion Dale Skeen, Menlo Park, CA (US)

(21) Appl. No.: 19/644,997

(22) Filed: Apr. 10, 2026

Related U.S. Application Data
(60) Provisional application No. 63/787,280, filed on Apr. 11, 2025.

(51) Int. Cl. G06N 5/022

(52) U.S. Cl. CPC G06N 5/022

(57) ABSTRACT

A knowledge-augmented Artificial Intelligence for IT and Network Operations (AIOps) system includes a knowledge plane with a structured knowledge data object and multiple AI Agents for evaluating devices in a Monitored System. At least some of the AI Agents share access to the structured knowledge data object via the knowledge plane.

### CROSS-REFERENCE TO RELATED APPLICATIONS

This Application claims the benefit of U.S. Provisional Patent Application No. 63/787,280, filed Apr. 11, 2025, which is incorporated by reference.

### BACKGROUND

### 1. Technical Field

The subject matter described relates generally to Artificial Intelligence for IT and Network Operations (“AIOps”) and, in particular, to incorporating structured knowledge that is shared between functions to provide improved AIOps.

### 2. Background Information

As modern IT and network environments grow in scale, complexity, and dynamism—particularly in domains such as telecommunications and cloud infrastructure—there exists a critical need for intelligent, adaptive operations that minimize human intervention while ensuring reliability, performance, and efficiency. The eventual goal of this drive toward increasing levels of automation in IT and Network Operations is futuristic goal of fully Autonomous Operations and “Self-Healing Networks.” However, there are several shortcomings in conventional AIOps systems that present significant obstacles in achieving this goal.

One such shortcoming is the structure of typical AIOps pipelines that use a series of highly specialized Agents that operate independently to perform different but related tasks. These Agents are individually trained, leading to slow upgrade cycles and potential inconsistencies between Agents, which is compounded by many Agents being “black-box,” meaning the generated predictions and actions cannot be explained. Furthermore, this black-box nature of Agents prevents sharing of what one Agent learns with another. For example, one Agent may identify a system interdependency or failure pattern, but this knowledge is not available to other Agents that might be able to leverage it to better perform their assigned functions. In sum, due to the fragmented, siloed, and black-boxed operations of the Agents, prediction accuracy is lost in each step, and this loss is magnified as processing proceeds down the pipeline.

Another shortcoming is data fragmentation. Topology data, configuration management data, and other contextual data is spread across multiple systems with the result that Metrics, Events, Logs, and Traces (“MELT”) data is not enriched with Topology data, dependency relationships, or other contextual data. Furthermore, existing contextual data is often incomplete, missing, or stale, especially in the case of Topology data. Conventional AIOps systems also have limited contextual awareness (e.g., having limited access to location data, such as whether a device is indoors or outdoors, or lacking information about weather conditions impacting outdoor equipment, etc.) and use naïve correlation algorithms. Typically, valuable information such as Fix Information is not available or only stored as unstructured data and is thus hard to utilize.

As a result of these limitation and shortcomings, the Agents employed in conventional AIOps deployments are often inadequate or immature—lacking the adaptability, accuracy, or explainability required for high-risk operational decisions. Compounding this are pitfalls in the contextual data itself, such as stale Topology information, incomplete dependency mappings, or noisy telemetry, all of which undermine effective root cause analysis and Likely Fix recommendation. As a result, these conventional AIOps systems require significant human oversight, preventing AIOps systems from realizing truly autonomous operations.

### SUMMARY

The above and other problems may be addressed by systems and methods for enhancing AIOps across various functions, such as ingestion of health and performance, anomaly detection, event correlation, root cause analysis, likely fix recommendation, and automated remediation. The disclosed techniques can improve the accuracy, speed, and contextual relevance of each AIOps function, enabling a more robust, autonomous, and self-healing operational framework. Various embodiments use Structured Knowledge (“Knowledge”), such as that embodied in a Knowledge Graph, to improve the accuracy, precision, and contextual relevance of AI outputs in a knowledge-augmented AIOps system. This structured knowledge is constructed and maintained as a unified, system-wide asset—continuously updated and accessible by multiple AI components. Through shared, semantically rich Knowledge, the knowledge-augmented AIOps system can provide more consistent reasoning, deeper correlation of events, improved root cause analysis, and more reliable decision-making throughout the AIOps pipeline. This approach addresses current limitations in isolated or model-specific learning, enabling more autonomous and adaptive operations.

The knowledge-augmented AIOps system may also provide a set of utilities that help to build the Knowledge Base, including techniques that automatically mine Knowledge from input data, such as the MELT data and service tickets that document the actions applied by human or automated Fix Agents that remediate the reported system problems.

### BRIEF DESCRIPTION OF THE DRAWINGS

FIG. 1 is a block diagram of a networked computing environment in which as AIOps system is deployed, according to one embodiment.

FIG. 2 illustrates the core structure of an AIOps system, according to one embodiment.

FIG. 3 illustrates a knowledge-augmented AIOps system with a knowledge plane that shares information between Agents, according to one embodiment.

FIG. 4 illustrates an example knowledge representation at class and instance levels, according to one embodiment.

FIG. 5 illustrates an example knowledge graph for a cellular network at class and instance levels, according to one embodiment.

FIGS. 6A and 6B illustrate the knowledge shown in FIG. 5A in alternative representations, according to various embodiment.

FIG. 7 illustrates the use of transformers to transfer information from data sources and between components of the AIOps system, according to one embodiment.

FIG. 8 illustrates an example visualization of a knowledge graph showing instances of cell site routers and aggregation routers affected by two overlapping instances, according to one embodiment.

FIG. 9 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Definitions

In the description below, the following terms generally have the following meanings, unless the context indicates otherwise. It should be appreciated that these definitions are provided as examples to aid understanding and should not be considered limiting.

Agent—a software component that provides a set of functions or performs a set of tasks. An Agent may be reactive and only act when called or triggered, or proactive, meaning it monitors the environment and acts accordingly. Note that Agent, as used herein, is broad use of the term and can include traditional software components.

AI—as used herein is a broad term that covers Machine Learning algorithms (ML), simple rules-based or policy systems, rules-based inferencing engines, Expert Systems, neural nets, and Generative AI, including those using SLMs and LLMs.

AI Agent—an Agent that uses AI.

AIOps System—a software-based platform or solution that leverages artificial intelligence (AI), machine learning (ML), or data analytics to automate and enhance IT operations, including but not limited to the monitoring, analysis, diagnosis, prediction, remediation, and optimization of IT infrastructure, applications, networks, and services. Such systems may include components for log and metrics ingestion, event correlation, anomaly detection, root cause analysis, and automated incident remediation, and are intended to support the reliability, performance, and scalability of enterprise IT environments and Telecom networks. As used herein, AIOps is broadly to include system monitoring and network monitoring platforms, and Observability systems and tools.

Class—refers to a categorical grouping of IT or network components that share common characteristics, functions, roles, or behaviors.

Component—when capitalized, means a physical or virtual component within the Monitored System, such a router, compute server, Virtual Machine, etc.

Device—when capitalized, means a Monitored Component

Fine-tuning—a LLM, SLM, Domain specific LLM means the process of adapting a pretrained language model by training it on additional data to modify its behavior, outputs, or domain knowledge for specific tasks, while preserving its foundational capabilities.

Fix Agent—a human, software script, or Agent that is responsible for remediating reported problems within the Monitored Systems.

Instance—a specific, identifiable realization of a Class.

Knowledge—(when capitalized) means Structured Knowledge that is generated, governed, or utilized by a Knowledge Plane or Knowledge System, and that supports semantic interpretation, automated reasoning, or interoperability across systems. Knowledge may be expressed in a variety of representational formats, including but not limited to Knowledge Graphs, textual representations, and machine-readable data structures,

Knowledge Augmented Retrieval—refers to a retrieval mechanism that enhances the performance, accuracy, and relevancy of generative AI models, including large language models (LLMs), by incorporating relevant Knowledge into the query and response generation process.

Monitored System—the system being monitored by the AIOps System, which be any size of IT Systems, from small systems to large system that span many data centers, mobile and fixed line Telco networks, or a combination of both. The Monitored System may be world-wide with a mix of Data Centers and networks spanning multiple geographic regions. Monitored Systems is an umbrella term that includes Monitored Network or any interconnected collection of IT or telecom devices.

Monitored Network—a data or voice network that is being monitored by an AIOps System.

Observability Platform (also referred to as an Observability Layer or Observability System)—a software system that provides interactive visual analytics designed to enhance understanding of a Monitored System and support operational decision-making by human operators. An Observability Platform may include: real-time dashboards for monitoring system health and performance, timeline visualizations to support root cause analysis, dynamic Topology and dependency maps for visualizing relationships among system components, and Interactive visual query interfaces that allow users to filter, pivot, and correlate telemetry data (e.g., metrics, logs, and traces) without the need for programming.

Structured Knowledge—knowledge that is organized in a defined and consistent way, making its components, relationships, and meanings explicit and accessible for use, interpretation, or communication by humans and machines.

Topology—refers to how the Components of the Monitored System are interconnected, including network links containment hierarchies, both physical and virtual, such as a network switch contains physical ports, or software application that runs inside a Virtual Machine (VM) which in turn runs inside a physical computer server located in a rack in a data center.

Topology Pattern—a recurring arrangement or configuration of interconnected Components within a Monitored System—such as nodes, services, or Devices—that reflects a known structure, function, or behavior. In network and IT operations, Topology Patterns are used to identify standard deployment architectures, dependency relationships, or communication flows across physical, virtual, or logical layers.

Virtual Component—a system or network component that is implemented in software rather than hardware.

### Overview

Modern IT operations—particularly those in cloud-native and telecommunications environments—face growing challenges driven by unprecedented scale, complexity, and operational fluidity. The widespread adoption of distributed systems, virtualized network functions, microservices, and hybrid infrastructure has rendered traditional monitoring and manual incident response methods increasingly ineffective. These legacy approaches often fail to deliver timely insights, correlate data across silos, or adapt to rapidly changing conditions within the operational environment.

To overcome these limitations, Artificial Intelligence for IT Operations (AIOps) has emerged as a transformative paradigm. AIOps solutions leverage a combination of machine learning, generative AI, advanced analytics, and automation to improve the reliability, agility, and performance of complex systems. These platforms continuously ingest and analyze diverse, high-volume data streams—such as metrics, events, logs, traces, (“MELT” data)-together with Topology data in order to detect anomalies, predict failures, correlate incidents, identify root causes, and trigger automated remediation workflows.

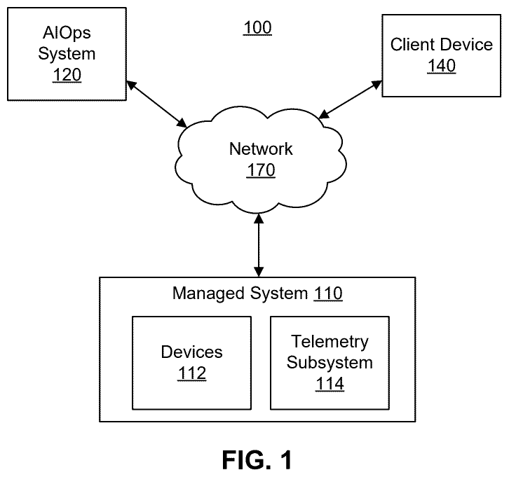

FIG. 1 illustrates one embodiment of a networked computing environment 100 in which an AIOps system 120 is deployed. In the embodiment shown, the networked computing environment includes a managed system 110, an AIOps system 120, and a client device 140, all connected via a network 170. The managed system 110 includes Devices 112 and a telemetry subsystem 114. In other embodiments, the networked computing environment 100 includes different or additional elements. Furthermore, the functionality may be distributed differently than described.

The managed system 110 can be an enterprise network, telecommunications network, or any other collection of Device 112 that coordinate via network communications to provide functionality. The Devices 112 are computing devices, which may include endpoints such as desktop, laptop, or server computers, as well as communications infrastructure devices such as routers, gates, firewalls, and the like. The managed system 110 includes a telemetry subsystem that generates telemetry data describing operations of the Devices 110 (e.g., MELT data) and makes the telemetry data available to the AIOps system 120.

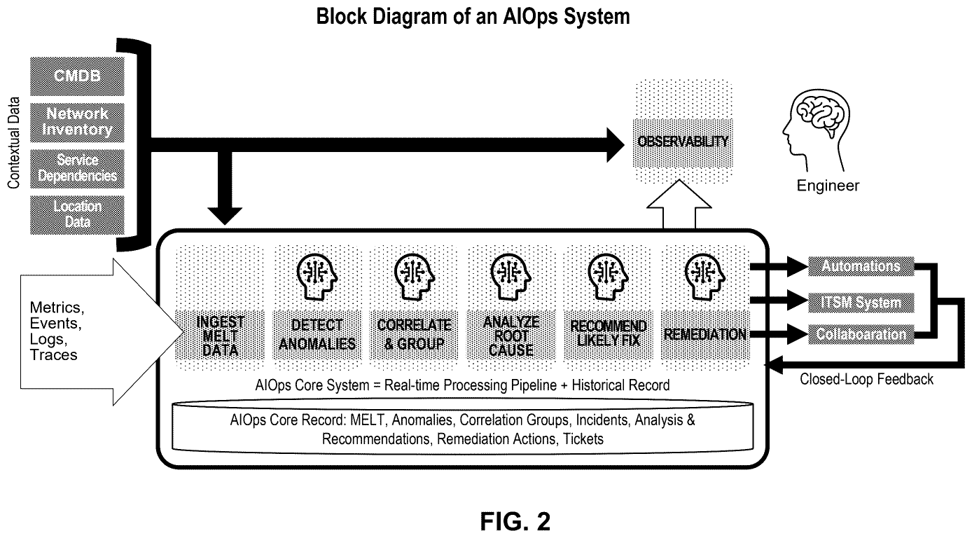

The AIOps system 120 includes one or more computing devices that ingests the telemetry data and provides functionality for managing operations of the managed system. In one embodiment, the functionality provided by the AIOps system includes anomaly detection, event correlation, root cause analysis, likely fix recommendation, and automated remediation. Each function can be provided by an AI Agent, at least some of which use information stored in a shared knowledge plane (e.g., a knowledge graph) with contextual information about the Devices 112 that is accessible by multiple AI Agents to provide improved correlation and accuracy between the operations of the AI Agents. Various embodiments of the AIOps system 120 are described in greater detail below, with reference to FIGS. 2 through 8.

The client device 140 is a computing device with which a user can configure and review the outputs of the various Agents of the AIOps system 120. Although the client device 140 is shown as distinct from the managed system 110, the client device 140 may be one of the devices 112 of the managed system 110. In one embodiment, the client device 140 provides a dashboard or other web-based interface with which users can configure the AIOps system 120 and review outputs from the AIOps system 120. For example, while the AIOps system may automatically attempt self-healing of the managed system 110 after detecting an issue, if self-healing fails or some other triggering condition is met (e.g., the detected issue is determined to be particularly serious) then the user may be prompted at the client device 140 to review the determinations may by the AIOps system 120 and select appropriate remedial action (e.g., from a list of suggested actions generated by the AIOps system 120).

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

### Example Systems

FIG. 2 illustrates the core structure of one embodiment of an AIOps system depicting the inputs and outputs, data processing pipeline, and data stored. In the embodiment shown, the inputs include the health and performance data collected from the Devices and Components in the Monitored System. This data typically consists of MELT data. The MELT data may include metric that are runtime measurements of significant indicators, such as CPU utilization, memory usage, network volumes, etc. The events in the MELT data may include failure alerts and change events such as a firmware upgrade. The logs in the MELT data may include system log records, typically delivered as same text messages in the “Syslog” format. The traces in the MELT data may include the call sequences (“traces”) of the applications running on the Monitored System.

The inputs to the AIOps system may also include contextual data about Components of the Monitored System, including its properties, configurations, location, Topology, and other any other factors that may influence operational health and condition.

The core of the AIOps System is the processing pipeline, depicted in the large box, which processes the MELT data input through a series of steps performing one or more of the following functions:
Ingestion of streams of operational health and performance telemetry data including Metrics, Events, Logs, and Traces (MELT).
Detection of anomalies, faults, and failures within the monitored data streams. “Noise reduction” may be performed at the same to eliminate redundant or unimportant events.
Correlation of individual faults and anomalies into groups, called Incidents, that are likely to have a common root cause. This is a particularly difficult task for large, complex systems since major incidents may have faults and anomalies spanning hundreds of Components, and at any point in time, the Monitored System may be experiencing thousands or tens of thousands of concurrent incidents.
Root Cause Analysis on incidents to determine the most probable root causes for those incidents.
Determining a likely fix (or fixes) based on the determined root causes and the types of Component involved.
Remediating identified issues. If an automated fix is available then it can be invoked, otherwise a “trouble ticket” may be produced and sent to an IT Service Management (ITSM) System. Additionally or alternatively, a message may be sent to site reliability engineers, often referred to as Fix Agents.

At the various steps in the processing pipeline, the contextual data is used to improve the analysis and recommendations. For example, the Topology data is used in the correlation step to help determine if the failures in two Components are related because one is linked to the other, or one is a part of the other. The historical data record can be stored of all or a subset of the MELT input data, and the results and recommendations at each step of processing.

In some embodiments, the AIOps system includes observability capability that provides a rich set of interactive visual analytics designed to enhance system understanding and operational decision-making. Components of the Monitored System can be visualized in a wide variety of ways, including Component health, the Components impacted by an incident, and their various interdependencies and relationships. These visual analytics and visual correlations make use of the AIOps real-time and historical data, the MELT data, and the context data.

The output of the AIOps system may include one or more of visualizations and visual analytics for humans using the observability capabilities, trouble tickets for ITSM systems, invocations of known automated procedures and orchestrators, or text summaries of the findings to site reliability or Fix Agents via email, text, or a collaboration tool like slack. Furthermore, the Fix Agents, the ITMS systems, and Automations may return back the resolution information about what fixes or automated procedures were applied and their success.

A successfully implemented AIOps system can provide several advantages to enterprises. These advantages may include: reduced alert fatigue by filtering out redundant alerts and correlating related alerts into incidents; faster incident detection and resolution through real-time analytics and automated root cause identification; improved system uptime and reliability (“service assurance”) by predicting potential failures and enabling proactive intervention, operational efficiency gains via automation of routine tasks such as incident triage, remediation, and reporting; optimized resource utilization through dynamic performance monitoring and workload balancing; enhanced scalability for managing complex hybrid and multi-cloud environments; or continuous learning and adaptation by leveraging machine learning models that evolve with new data. Thus, an AIOps system may improve the degree of autonomous operations of a network and provide self-healing for at least some problems with the network, where the tasks of detecting, analyzing, and acting on anomalies and outages are automated, reducing or eliminating human involvement. The long-term goal of AIOps is to enable Autonomous Operations and Self-Healing Networks, where the tasks of detecting, analyzing, and acting on anomalies and outages are completely automated.

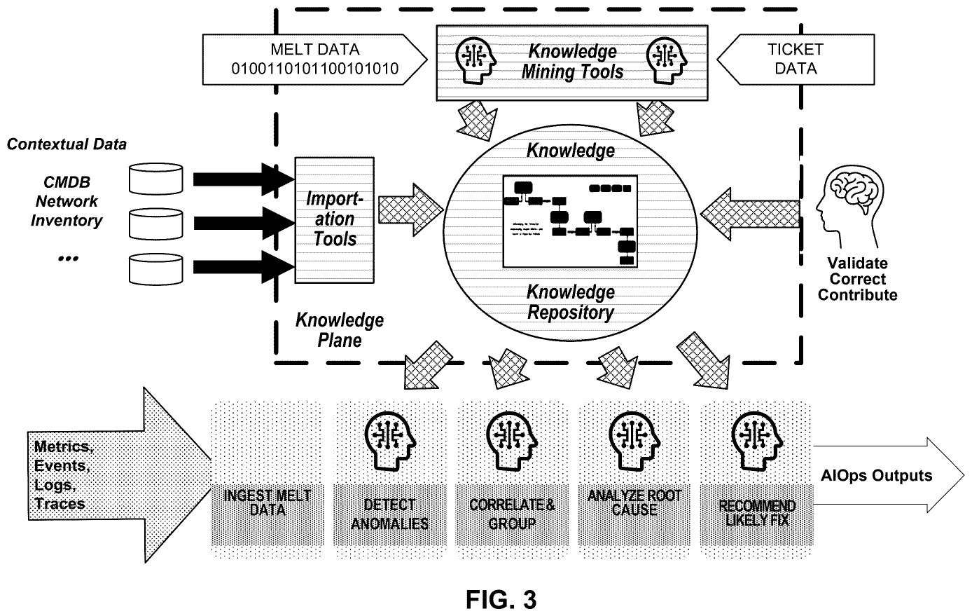

FIG. 3 illustrates one embodiment of a knowledge-augmented AIOps system that uses a knowledge plane that shares information between Agents to improve the accuracy, precision, and contextual relevance of AI outputs. The knowledge-augmented AIOps system includes Knowledge, typically stored as Knowledge Graph or similar data structure, containing knowledge about the Monitored System or network, including network and system Topology, known and learned dependency relations among system Components, diagnostic knowledge, knowledge on how to remediate faults, or any other contextually relevant information. The Knowledge Graph (or similar data structure) and corresponding knowledge repository, together with the tools for accessing, building, importing, mining, maintaining, sharing, and governing Knowledge, may be collectively referred to as the “Knowledge Plane.”

The knowledge-augmented AIOps system also includes an AIOps pipeline, in total or partial, stand-alone or embedded within a system. The AIOps pipeline includes a set of AI Agents that performs functions including one or more of observability, anomaly detection, correlation across system layers, root cause analysis, likely fix recommendation, and automated ticketing or remediation, where one or more of the Agents implementing the AIOps functions utilizes the Knowledge in the Knowledge Repository, either directly or indirectly through a Connector or some sort of adaptor.

In FIG. 3, the Knowledge Mining Tools, Knowledge Repository and Importation Tools all use or process Knowledge. Furthermore, the “digital heads” on the Detect Anomalies, Correlate & Group, Analyze Root Cause, and Recommend Likely Fix Agents within the AIOps processing pipeline indicate that these Agents have been built or adapted to consume Knowledge. For instance, the Correlate & Group Agent may leverage Knowledge about dependencies between system Components to improve event correlation accuracy. Similarly, the Recommend Likely Fix Agent can draw upon Knowledge regarding the historical success rates of various remediation actions—Knowledge that may have been extracted from ticket data in ITSM systems.

The Knowledge Repository can include any information that could be helpful to diagnose and triage problems in the Monitored Systems that is a candidate for conversion into structured knowledge and adding to the knowledge repository. A non-exhaustive list of the types of useful information represented includes: topologies across all layers of network and IT infrastructure, including known service dependencies; learned and inferred dependencies; failure patterns; dependencies derived from telemetry data; diagnostic Knowledge (e.g., key symptoms, likely resolutions inferred from historical ticket data, etc.); contextual Knowledge about environmental and external factors (e.g., physical facility layout, geographic locations, etc.); and Device information including Classes, properties, failure behaviors, and history.

In one embodiment, Knowledge is maintained for system Components at both the Class level and the Instance level. Similarly, Topology information may be kept at the Topology Pattern level, which shows how Classes are related within recurring topologies, and at the Instance level, showing the actual Devices within a Topology.

By incorporating Knowledge into the operation of agents, the individual performance of each may be improved. The Correlation Agent, augmented with dependency Knowledge, can correctly group Entities that span technology stacks, organizational boundaries, and data silos. These are correlations that time-based or topology-only algorithms cannot make. This can reduce false positives, eliminate spurious Incidents, and surface true Incidents that would otherwise remain undetected in the noise.

The Root Cause Analysis Agent, reasoning over a unified and semantically enriched Knowledge Graph, can traverse multi-hop dependency chains to identify the true origin of cascading failures, rather than misidentifying a downstream symptom as the root cause, which is the dominant failure mode of RCA systems operating without dependency context.

The Likely Fix Agent, drawing on statistically mined remediation Knowledge, can replace ad hoc human judgment with empirically grounded recommendations ranked by historical success rate, Entity Class, and Symptom type. This can accelerate resolution, reduce the mean time to repair, and encode institutional knowledge that would otherwise walk out the door with experienced engineers.

The Observability layer, enriched by the Knowledge Repository, presents operators with dependency-aware visualizations that can make the propagation path of failures immediately apparent, transforming a wall of alerts into an intelligible causal narrative.

The Knowledge Mining algorithms (E.G., for dependencies, remediations, and Entity relationships from MELT data) CAN continuously extract latent Knowledge from operational data that existing systems discard or ignore, converting the AIOps system's own operational history into a continuously expanding asset.

### Example Knowledge Representations

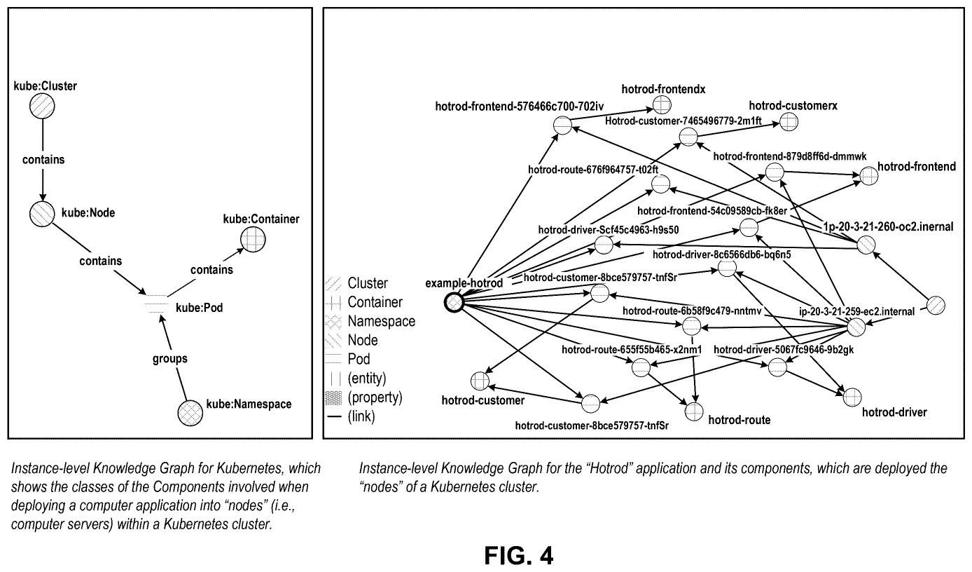

Several examples of Knowledge representations are given in the FIGS. 4 through 6B, and include Knowledge at the Class and Instance level. All examples display Knowledge in a graphical format (i.e., as Knowledge Graphs). The Knowledge can be stored in any suitable format, such as a standard RDF format.

FIG. 4 illustrates a Kubernetes deployment within a data center, according to one embodiment. On the left is a class-level knowledge graph, which shows the classes of the Components involved when deploying a computer application into nodes (i.e., computer servers) within a Kubernetes cluster. As illustrated, the cluster contains a node that in turn contains a pod. A namespace defines a group for the pod, which also contains a container for executing one or more applications. On the right is an instance-level Knowledge Graph for an example “Hotrod” application and its components, which are deployed to nodes of the Kubernetes cluster. As illustrated, the cluster contains various nodes, pods, and containers, which are grouped according to one or more namespaces.

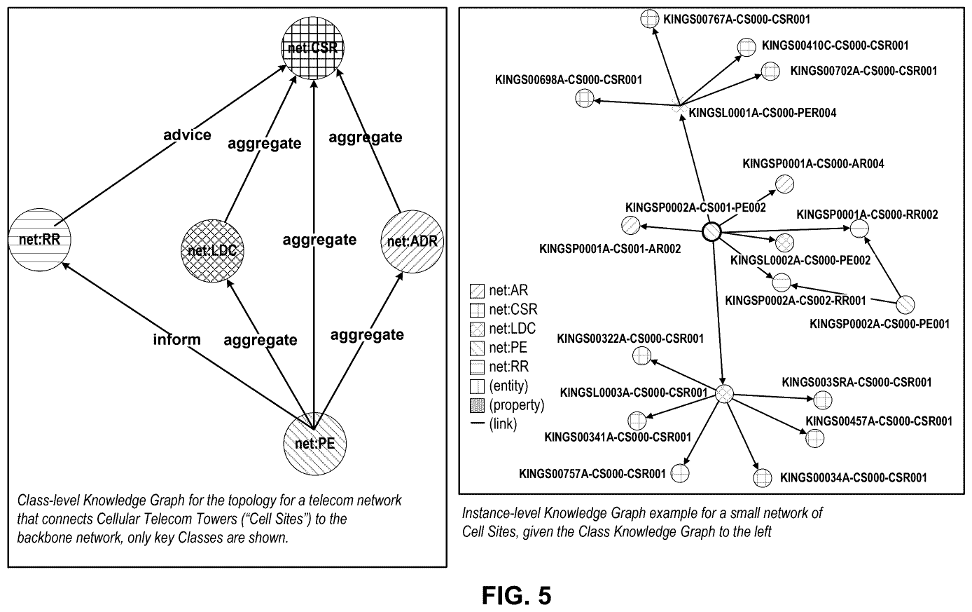

FIG. 5 shows example Knowledge Graphs for a cellular phone network, which capture the relationships and dependencies between the network routers at Cellular Telecom Towers (referred to as “Cell Sites” or “CSRs”) back to the network routers that connect to the telecom provider's backbone network. On the left is a class-level knowledge graph for the topology of the network that connects the CSRs to the backbone network. To clearly illustrate the general principles, only key Classes are shown. On the right, an instance-level Knowledge Graph for the cellular phone network is shown.

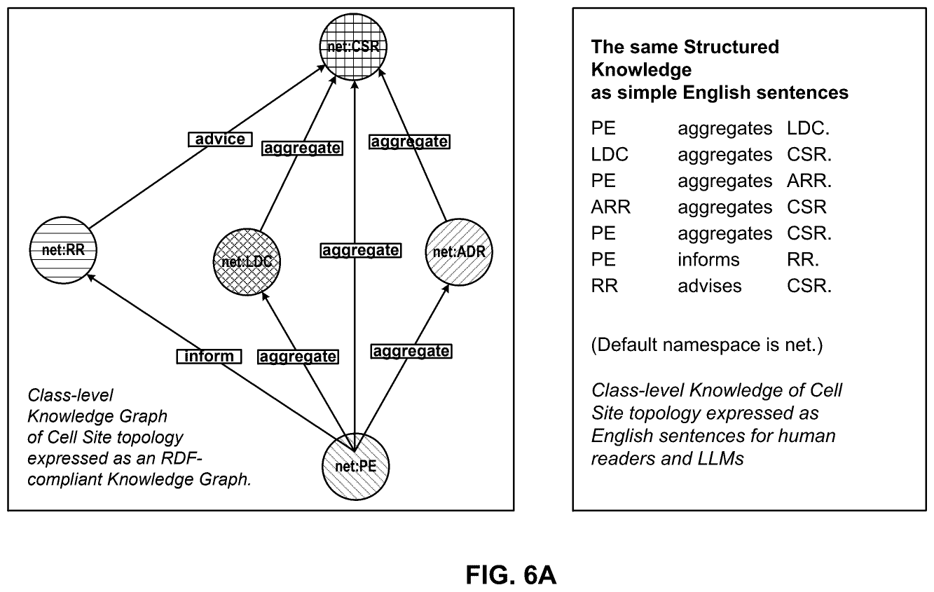

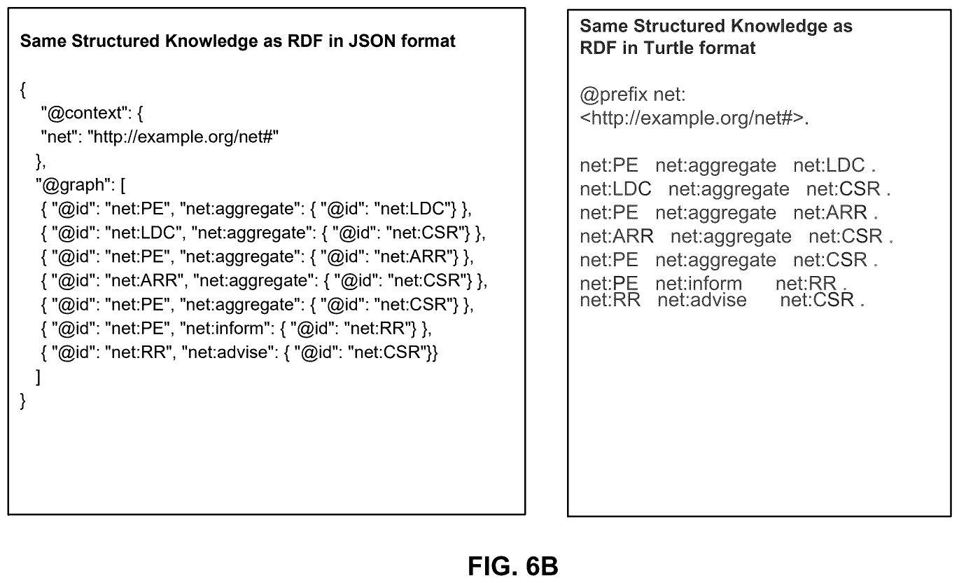

Although, the Structure Knowledge in these examples are represented as graphs, the equivalent Knowledge could be stored in variety of graphical and text formats. FIGS. 6A and 6B illustrate alternative data structures other than Knowledge Graphs that may be used to store Knowledge in an organized manner. Specifically, the equivalent Knowledge to FIG. 5 can be stored in natural language text format for human readers and various machine readable text formats for Agents and other software Components.

As described previously, the Knowledge Plane refers to a logical collection of services, utilities, and tools that collectively implement the core capabilities required to discover, query, infer, curate, maintain, and govern Knowledge within a distributed system. In one embodiment, representative Components and capabilities of the Knowledge Plane include:
Knowledge Repository-A centralized or distributed repository that stores structured Knowledge in a form suitable for querying, indexing, and updating. The Knowledge Repository can be stored using any suitable technology, such as relational database systems, graph databases, or big data platforms such as Apache Spark® or Google Spanner®.
Knowledge Service—A service-oriented API layer that provides a high-level abstraction for querying and updating Knowledge, while insulating client applications from changes in the underlying storage infrastructure. The Knowledge Service may support both read and write operations and can support multiple interaction modes, including synchronous queries, batch interfaces, and streaming protocols.
Centralized or Federated Deployment—The Knowledge Plane may be implemented as a monolithic central service or as a federated architecture in which Knowledge is partitioned across multiple Knowledge Repositories, which may differ in implementation details. The Knowledge Service API can be configured to route incoming requests to the appropriate underlying repository based on content type, location, or system policy.
Open Standards—he Knowledge Plane can support standard data interchange formats such as RDF (Resource Description Framework), which is used as the de facto representation for semantic Knowledge. Alternative or complementary formats, including relational schemas and JSON-LD, may also be supported.
Knowledge Import/Export Tools (including Transformers)—A set of tools for exchanging Knowledge between systems, Agents, or utilities. These tools may support both proprietary and standards-based data exchange and may leverage “Transformers” (described in greater detail below), which translate data to or from an appropriate Structured Knowledge representation.
Knowledge Mining and Discovery Tools—Automated utilities for extracting latent or implicit Knowledge from raw data sources. Examples include identifying service or network dependencies from telemetry data (e.g., MELT), or deriving “likely fixes” and their effectiveness based on historical ticket data that includes annotations from site reliability engineers responsible for fixing the identified problems.
Knowledge Inferencing and Reasoning Tools—Capabilities that enable the system to infer new Knowledge from existing data. For instance, deducing that two differently labeled system devices refer to the same physical asset based on similarity in properties, relationships, or behavioral patterns.
User tools for curating, verifying, and correcting Knowledge—Interfaces for human subject matter experts to verify, correct, or enhance Knowledge artifacts. These tools may support workflows for approving, annotating, or deleting automatically generated Knowledge entries.
Administration Tools—A set of tools for managing access to both Knowledge and Knowledge Plane utilities. Access may be governed by user identity, role-based policies, or contextual attributes such as time and location.
Automated Maintenance Utilities—Background processes that enforce data retention policies, perform consistency checks, and execute other routine operations for maintaining the integrity and relevance of the Knowledge base over time.

### Example Use of Transformers

As mentioned previously, Transformers are software Components that can be used to convert Knowledge from one representational format to another (e.g., from RDF to JSON-LD or Turtle). Transformers may operate at the interface between raw data and Knowledge, performing conversions in both directions. When used in this context, such Components may be referred to as Data Transformers. Data Transformers may, for example, ingest structured data from a Configuration Management Database (CMDB) or network inventory system and translate it into a standardized Knowledge representation, such as RDF. Conversely, they may export Knowledge from the Knowledge Store into the format required by external systems, such as CMDBs.

In machine learning contexts, a Data Transformer may convert Knowledge into a format suitable for consumption by an ML-based Agent. For instance, a categorical property within the Knowledge Graph may be transformed into a one-hot encoded vector to serve as input to a machine learning model.

In various embodiments, Transformers are used to enable the integration of non-Knowledge-aware Components into a Knowledge-Augmented System. This transformative capability can enable Knowledge-Augmented Systems to be extensible and interoperable, accommodating a mix of knowledge-augmented AI Agents, traditional AI and machine learning components, and conventional software components. Over time, as more components become Knowledge-aware in a system, the need for these intermediary transformations diminishes, but during the transitional state as Knowledge-awareness is being deployed, Transformers enable system-wide Knowledge usage and semantic integration.

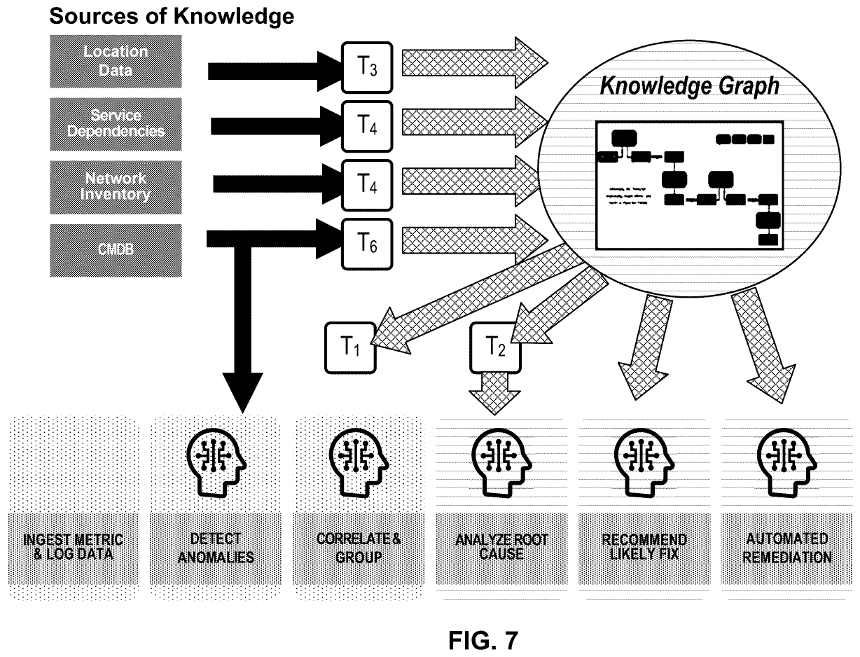

FIG. 7 illustrates one embodiment of a knowledge-augmented AIOps system that uses Transformers to incorporate Knowledge into the operation of conventional components that were not designed to consume Knowledge. In FIG. 7, the sources of contextual Knowledge have not yet been converted to be Knowledge-aware, and continue to maintain their “knowledge” as conventional data stored in traditional databases. This data from each source is extracted, transformed into Structured Knowledge, and then stored in the Knowledge Repository. Since each source uses a distinct data format and schema, a custom Transformer is used for each, represented by T₃ through T₆.

Within the AIOps processing pipeline, the Detect Anomalies and Correlate Agents have not been adapted to use Knowledge. The Detect Anomalies Agent continues to rely on conventional data interfaces. However, the Correlate Agent accesses the Knowledge Repository through a Data Transformer (T₁), enabling it to operate over structured, semantically enriched Knowledge. In some embodiments, because the Knowledge Repository aggregates Knowledge from multiple heterogeneous sources—including some content that is curated or verified by subject matter experts—the Correlate Agent can benefit from richer and more accurate contextual information, potentially improving the precision and effectiveness of its analysis.

The Agent responsible for Root Cause Analysis is Knowledge-Aware, but requires Knowledge in a different format than supported by the Knowledge Service API. A Transformer, T₂, is used to translate between the Knowledge formats.

In this scenario, the Knowledge Plane functions as an integration hub, centralizing access to high-quality Knowledge across the system. In a conventional architecture, Agents would otherwise be required to individually integrate with multiple, disparate data sources, increasing system complexity and the burden of integration logic. The Knowledge Plane thus can provide significant improvement over conventional systems and, with the use of Transformers, be added to upgrade existing systems in a modular fashion.

### Further Example Features and Benefits

Various embodiments of the AIOps system include one or more of the following example features and may provide one or more of the described benefits. It should be appreciated that not all embodiments will include all of these features or provide all of these benefits. Furthermore, other embodiments may include different or additional features and provide different or additional benefits.

### Knowledge-Enabled Observability

The use of Knowledge can improve observability of the managed system. Specifically, the use of Knowledge can significantly enhance the visualizations and visual analytics provided by observability platforms and AIOps systems. By leveraging the Knowledge Base, these systems gain access to richer contextual information, including more complete topologies and Component dependencies, which can be visually represented to improve clarity and insight. Knowledge also enables explanatory overlays—helping users understand what is being visualized and why it matters.

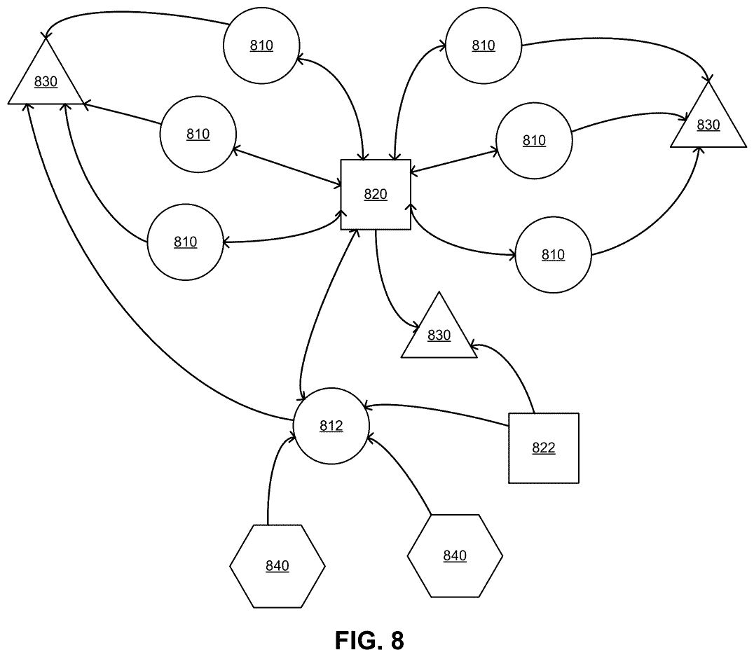

For example, a visualization of a knowledge graph showing Components affected by an incident can highlight all known dependencies among those Components and visually trace the path to the root cause, either through dynamic visuals or explanatory text. This capability can be particularly valuable when dealing with dynamic relationships that evolve frequently and are not captured in static CMDBs or inventory systems. FIG. 8 illustrates an example knowledge graph visualization that provides additional insights into the impact of two overlapping incidents.

The knowledge graph depicts the Instances of cell site routers 810, 812 (depicted as circles) and the Instances of aggregation routers 820 (depicted as squares) affected by the two overlapping incidents. The triangles represent connection speeds 830 between routers (e.g., Gigabit, 10 Gigabit, 100 Gigabit) and the hexagons represent router reflectors 840. The router reflectors periodically send routing table updates to other routers. The graph visually represents the Instances of the routers and their topological dependencies as edges, all of which have been stored in the Knowledge Graph. In this scenario, the failure of the top AR 820 impacts all of the CSRs 810, 812, while a single link failure in the bottom AR 822 affects only a single CSR 812, which has become isolated due to the loss of communication with both ARs and/or router reflectors 840 it depends on. A subject matter expert—such as a site reliability engineer—could inspect this Knowledge Graph and immediately identify the isolated CSR 812, thanks to the visual clarity and contextual relationships encoded in the graph.

### Knowledge Mining From Melt Data

Knowledge mining can be used for automated discovery of new, structured Knowledge from data sources. In one embodiment, knowledge mining is used to extract Knowledge from the MELT data streams ingested by the AIOps system. These data streams contain a wealth of implicit relationships and behavioral patterns across different classes of system entities. As an example, in the context of a Kubernetes environment, the MELT data is naturally partitioned into multiple distinct streams corresponding to major entity Classes, including containers, pods, and the nodes on which they execute. The MELT data for a given container typically includes references both to the container instance and to the pod instance in which it runs. Likewise, the MELT data for a pod includes references to both the pod instance and the node instance that hosts it.

By detecting these co-occurrences—e.g., container-to-pod and pod-to-node mappings—within individual records, the system can infer runtime relationships that are not explicitly documented. These inferred relationships can be used to construct Knowledge Graphs that capture the dynamic Topology and operational context of the Kubernetes cluster. Such graphs are instrumental in downstream analysis performed by the various AIOps Agents, including event correlation, impact analysis, and root cause analysis.

Each MELT data stream is composed of a time-series sequence of structured records, with each record containing a set of fields. Some of these fields contain unique identifiers for the entities included in the Monitored System. Such unique Entity identifiers are referred to as UIDs or EntityIDs. An entity may be identified by multiple UIDs.

In general, each record represents a monitoring event for a single monitored entity, which is typically the main subject of the measurements and associated metadata. Entities within the system are typically grouped into semantic Classes or sets, such as routers, hosts, or services. Importantly, field names across different MELT sources are not always standardized; as such, fields referencing the same Class of entity may use inconsistent or ambiguous names. Consequently, field names alone are insufficient to reliably determine the Class of an entity being referenced.

Fields, also called dimensions or properties, in MELT records typically include: the UID of the monitored entity (also known as the key); UIDs of related entities (also known as foreign UIDs or foreign keys); categorical properties describing attributes of the monitored entity; free-text fields; and one or more numeric measurements indicating the health or performance of the monitored entity.

In a MELT stream, the field that identifies the monitored entity is the field that exhibits the highest cardinality among all fields, excluding measurement and text fields, and is referred to as the primary key. Here the usage of the term primary key is the same as its usage in database terminology. All other fields containing categorical fields or Entity IDs are functionally dependent on it. This relationship can be verified using a functional dependency test.

In the special case where two or more fields exhibit the highest cardinality and each independently satisfies the functional dependency test, all such fields are treated as key fields, and are considered synonyms. One of these fields is designated as the primary key field, while the remaining fields are designated as secondary key fields. For each value in a secondary key field, an alias relationship can be added to the Knowledge Graph, linking the secondary key value to its associated primary key value.

The extent of the monitored entities can also be learned from the MELT data. The extent of the monitored entities refers to the complete set of monitored entities occurring in the MELT data stream. Each entity is identified either directly by its primary key or indirectly through an alias relationship to the primary key. In one embodiment, to construct this extent, the system collects all unique Entity UIDs found in each MELT record field that has been identified as either a primary or secondary key. These UIDs serve as the foundation for building the corresponding Knowledge Graph or other Structured Knowledge representation of the Monitored System.

Relationships may also be inferred from foreign keys. In one embodiment, fields in a MELT data stream that reference entities other than the monitored entity are treated as foreign keys. The co-occurrence of a monitored entity and one or more foreign key UIDs within a record implies the existence of a relationship between the two. These relationships are represented in the Knowledge Graph as directed edges from the foreign entity (the dependent entity) to the monitored entity (the primary entity). The semantics of the relationship may be topological (e.g., a virtual or physical connection between the two entities), hierarchical (e.g., containment or hierarchical cable network), or of another type, depending on the system context. The process described above can be formalized as a sequence of steps for automated Knowledge extraction, as outlined below.

The system automatically determines which fields contain Entity IDs by analyzing cardinality. The system also “learns” relationships among entities through the pattern of co-occurrences of Entity IDs in the MELT data records.

Step 1: Iterate Through Each MELT Data Stream. For each MELT data stream, retrieve the full sequence of structured records.

Step 2: Identify Candidate UID Fields. For each field in the stream, compute the cardinality of the field and identify fields with high cardinality as potential Entity ID fields. (UIDs).

Step 3: Determine the Monitored Entity. From the candidate UID fields, select the field with the highest cardinality that satisfies a functional dependency test (i.e., other fields depend on it) and designate this field as the primary key for the monitored entity. If two or more fields qualify, select one as the primary key and designate the others as secondary keys. For each secondary key value, define an alias relationship to the corresponding primary key value.

Step 4: Build the Extent of Monitored Entities. Collect all unique primary and secondary UIDs from the identified key fields. These uniquely identify the monitored entity Instances. Record each unique UID in the Knowledge Graph as an entity node and record each alias as a synonym relationship in the Knowledge Graph between the two referenced entity nodes.

Step 5: Extract Foreign Keys and Infer Relationships. Examine all remaining UID fields in each record. For each UID that is not a key field in the monitored entity, treat it as a foreign key referencing a related entity and record a directed relationship (link) in the Knowledge Graph from the foreign entity to the monitored entity. Optionally, the system may classify the relationship (e.g., topological, containment, logical) based on domain knowledge or schema metadata.

Step 6: Finalize and Store the Knowledge Graph. After all records are processed, compile the set of entities, aliases, and inferred relationships, and store or export the result as a Knowledge Graph, ready for downstream AIOps use (e.g., correlation, RCA, impact analysis).

It should be appreciated that while the algorithm is described in the context of learning relationships from MELT data streams in IT and Network Operations, the same or a similar algorithm may be applied to broader classes of Entities and data sources. Specifically, the algorithm is applicable to any Entity qualifying as an Object in the RDF Schema (RDFS) data model, and to any structured data collection whose records reference such Entities, including relational database tables, CSV files, and tabular data stored in file systems or data warehouses.

In the IT and Network Operations context, such collections may contain contextual Entities that influence operational outcomes but are not themselves monitored system components. Examples include: named geographic locations; physical facility and infrastructure records; personnel and organizational assignments; customer accounts and service agreements; fault symptoms and diagnostic codes; and remediation scripts and automated procedures. Relationships among such non-system Entities, and between non-system Entities and monitored system components, are contextual Knowledge that enriches the Knowledge Repository and can improve the accuracy of downstream AIOps functions.

The algorithm is further applicable to domains entirely outside of IT and Network Operations. The core mechanism—identifying Entity identifiers within structured records by cardinality analysis, designating Primary and Secondary Keys, and inferring relationships from co-occurrence patterns—is domain-agnostic and imposes no requirement that Entities be system components or that data sources be operational telemetry.

In some embodiments, whether within or outside the IT Operations domain, data fields containing continuous numeric measurements, timestamps, or unstructured free-text are excluded from consideration as candidate Entity identifier fields, consistent with the field classification methodology described previously. The algorithm may be applied to discover relationships within a single data collection or across multiple data collections, by treating co-occurring Entity identifiers across collection boundaries as evidence of inter-collection relationships. This capability is useful across a broad range of problem domains wherever latent relational structure among discrete Entities is encoded implicitly within structured records.

Mining Diagnostic and Remediation Knowledge from Trouble Tickets, Repair Logs, and Trouble Shooting Guides

Trouble Tickets (or simply “Tickets”) are another source for mining for Knowledge. Tickets, or a similar electronic or paper artifact, are generated, either manually or automatically, when Incidents are detected. Such Tickets contain diagnostic data about the Incident including the Faults and affected Entities that have been correlated together. When a repair is successfully made to an Entity, the repair is normally recorded in the Ticket and the Ticket is “closed.” Other data such as remediation logs and engineering notes may supplement the Tickets. These artifacts contain implicit knowledge about the remediations and fixes actually applied, versus those that were recommended. They also contain the outcomes achieved, and specifically whether the applied remediation was successful in fixing the problem.

The goal of mining the Tickets, logs, and notes is to identify patterns associating faults and anomalies to the recommended remediations, applied remediations, and outcomes. These patterns represent untapped knowledge that can be converted into Structured Knowledge and then utilized by appropriate AI agents.

The algorithms in this section assume that each Ticket (possibly in combination with associated data such as remediation logs and engineering notes) contains:
A unique Incident Identifier;
A list of Faults and Anomalies (collectively referred to as “Symptoms”) that have been correlated together into the Incident;
The Managed Entities associated with the Faults and Anomalies;
The Lead Symptom, which is the earliest Symptom recorded in the Ticket;
The Lead Entity, which is the Managed Entity associated with the Lead Symptom;
The Repaired Entity is the Entity that was repaired by the Fix, which may differ from the Lead Entity;
The Fix, which is the repair action (i.e., “Fix”) performed. To be useful. The Fix needs to be distilled down to a small number of categorical repair actions, such “reboot”, “add memory”, “replace power supply”, and indicate whether the action is to be applied to the Lead Entity or an adjacent Entity in the same Incident; and
The Outcome of applying the Fix, including an indication of success or failure.

In other embodiments, tickets may include different or additional information.

Regardless of the specific information expected, for Tickets that do not contain all of the expected fields, a number of pre-processing steps can be applied to the available Ticket data and their associated notes and logs. These pre-processing steps augment the original Tickets with missing information. Such steps can include:
Time-sorting the Symptoms to identify the Lead Symptom and its associated Lead Entity;
Parsing the notes and logs associated with a Ticket to extract Fix and Outcome data, and then adding such data to the Ticket if missing;
Adding the general Entity Class of the Lead Entity if it is not recorded in the Ticket. Examples of Entity Class include host, router, database, service, Kubernetes container, and Kubernetes pod; or
If present, adding the Symptom type.

Once the Tickets have been augmented with available data, Knowledge Mining algorithms can be applied to discover relationships among Lead Symptom, Lead Entity Class, Fixes, and their success rates. These relationships can be expressed as knowledge and captured in troubleshooting guides and Likely Fix recommendation engines that are used by humans, AI-based Agents, and non-AI Agents to remediate (i.e., “fix”) problems occurring in the system.

In one embodiment, the Ticket Mining Algorithm includes the following operations. First, the AIOps system collects historical Tickets associated with previously closed Incidents over a span of time (e.g., 3 to 6 months). Second, the AIOps system normalizes features in the Tickets by mapping Lead Entities to Entity Classes, adding binary Outcomes (e.g., True if the issue was fixed, or False otherwise), and assigning “null” values for missing or unknown features. Third, the AIOps system aggregates counts over the normalize Tickets. This may be done by counting every observed combination of Symptom, Entity Class, and Fix for which the Outcome is True and counting every observed combination of Symptom and Entity Class. Fourth, the AIOps system computes conditional probabilities for each Fix F given a Lead Symptom S and an Entity Class C as follows: Cond. Prob. (F given S, C)=Count(S, C, F)/Count(S, C).

One embodiment of pseudocode for steps three and four of this algorithm is:
Input:
   Tickets=set of normalized tickets (Symptom, Entity, EntityClass, Fix, Outcome)
Output:
   CountSCF[S, C, F]—a map with keys S a Symptom, C an Entity Class, F a Fix
   SuccessCountSCF[S, C, F]—a map with keys S a Symptom, C an Entity Class, F a Fix
   ProbSuccessSCF[S, C, F]—a map with keys S a Symptom, C an Entity Class, F a Fix
Algorithm:
   1. Initialize:
      CountSCF=empty map with default value 0
      SuccessCountSCF=empty map with default value 0
      ProbSuccessSCF=empty map with default value 0.0
   2. For each ticket T in Tickets:
      S=T. Symptom
      C=T. EntityClass
      F=T. Fix
      O=T. Outcome
      If O==Success:
         CountSCF[S, C, F]=CountSCF[S, C, F]+1
         SuccessCountSCF[S, C, F]=SuccessCountSCF[S, C, F]+1
   3. For each triple (S, C, F) appearing in CountSCF:
      If CountSCF[S, C, F]>0:
         Probsuccessscf[s, C, F]=Successcountscf[s, C, F]/ Countscf[s, C, F]
      Else:
         ProbSuccessSCF[S, C, F]=0
   4. Return Maps Countscf, Successcountscf, Probsuccessscf

The counts and probabilities computed below are stored in a “map”, which is an associative data structure indexed by composite keys. Below, each composite key comprises a Symptom, an Entity Class, and a Fix, and the corresponding stored value represents the count or probability associated with that combination. Also, the values in the ProbSuccess map are the statistical “conditional probability” of Fix F being a correct, given Symptom S and Entity Class C.

The remediation knowledge mined from the Trouble Tickets can be stored in a Knowledge Graph and used in a variety of ways. For example, the mined knowledge can be extracted into a Trouble-Shooting Guide suitable for both human and automated agents. It can also be used to build a “Likely Fix” Recommendation Engine. A specific example of storing this information in a Knowledge Graphs using RDF is described in the worked examples below.

Representing the learned remediation knowledge in RDF provides advantages over storing the same knowledge solely in a relational database, including more explicit semantic representation of relationships, easier integration with other operational and ontological knowledge, greater schema flexibility, improved explainability, support for reasoning over classes and relationships, and improved sharing of the learned knowledge among multiple human and software agents. In some embodiments, the learned statistics are computed in a tabular or relational form and then transformed into RDF for storage as Structured Knowledge in a Knowledge Graph.

### Mining Trouble Tickets for Dependence Knowledge to Improve Correlation

This section discloses an algorithm for mining implicit dependency relationships among Entities from Trouble Ticket data. Unlike the remediation knowledge mining algorithm described previously, which focuses on associating Symptoms and Entity Classes with successful Fixes, this algorithm focuses on inferring undocumented dependencies between pairs of Entities based on their co-occurrence patterns across Incidents.

In one embodiment, a Trouble Ticket contains the set of Entities and their associated Signals that have been correlated together into an Incident. Existing correlation algorithms often fail under realistic operating conditions. Many fail due to missing dependency information —specifically, the absence of records indicating that Component B depends on Component A and will therefore fail if A fails. The sources of this gap in Knowledge include stale or incomplete data in CMDBs and Network Databases, as well as undocumented cross-stack dependencies, such as an application's dependency on a service implemented by a Pod running in a Kubernetes cluster.

When a Trouble Ticket is generated, it contains the list of Entities correlated into the underlying Incident. However, this correlated set is often incomplete or incorrect. Engineers handling the Ticket will frequently make corrections, adding or removing Entities, or combining or splitting Tickets, to reflect the true scope of the problem. These corrected Tickets encode implicit knowledge that exists only in the heads of experienced Engineers and is not present in any external data source.

If two Entities frequently appear together in the same Incident, there is likely a dependency relationship between them, even if that dependency is not recorded in any CMDB, Network Inventory System, or other configuration data source. This is particularly valuable for capturing cross-stack dependencies that are routinely absent from conventional sources, such as an application's implicit dependency on a Kubernetes Pod or a network service's dependency on a physical router.

In some embodiments, the Ticket Dependency Mining Algorithm performs the following operations:
(1) Collect the input set of Tickets, including Corrected Tickets, that correspond to successfully remediated Incidents. Corrected Tickets are particularly valuable as they reflect the judgment of experienced Engineers who have verified the set of Entities involved in each Incident, removing spurious correlations and adding missing Entities that automated correlation may have overlooked.
(2) Compute the set of all Entities E appearing in at least one Ticket. Specifically, for each Ticket T in the input set, collect all Entity identifiers referenced in T. The union of these sets across all Tickets constitutes the full Entity population over which dependency relationships will be computed.
(3) For each ordered pair of distinct Entities (Eᵢ, Eⱼ) drawn from E, perform the following computations:
   (a) Compute the co-occurrence count Co(Eᵢ, Eⱼ), defined as the number of Tickets in which both Eᵢ and Eⱼ appear together. That is: Co(Ei, Ej)=|{T∈Tickets: Ei∈T and Ej∈T}|
   (b) Compute the marginal occurrence count Ct(Eᵢ), defined as the number of Tickets in Which Entity Eᵢ Appears in at Least One Ticket: Ct(Ei)=|{T∈Tickets: Ei∈T}|
   (c) Compute the Conditional Probability of Eᵢgiven Eⱼ, denoted CP(Eᵢ|Eⱼ), as the fraction of Tickets containing Eⱼ that also contain Eᵢ: CP(Ei|Ej)=Co(Ei, Ej)/Ct(Ej)
   (d) Compute the Conditional Probability of Eⱼ given Eᵢ: CP(Ej|Ei)=Co(Ei, Ej)/Ct(Ei)
      Note that in general CP(Eᵢ|Eⱼ)≠CP(Eⱼ|Eᵢ), and this asymmetry carries semantic significance. A high value of CP(Eᵢ|Eⱼ)—meaning Eᵢ almost always appears when Eⱼ appears—suggests that Eᵢis dependent on Eⱼ, or equivalently, that Eⱼ has a broad impact on Eᵢ. Conversely, a high value of CP(Eⱼ|Eᵢ) suggests the reverse. When both conditional probabilities are high, the two Entities are likely tightly coupled, either through mutual dependency or through a common upstream cause.
(4) Apply a minimum support threshold to filter out Entity pairs with insufficient co-occurrence evidence. Pairs for which Co(Eᵢ, Eⱼ) falls below a configurable minimum support count are excluded from further consideration, as their conditional probabilities would be statistically unreliable.
(5) For each Entity pair (Eᵢ, Eⱼ) that survives the support threshold, classify the inferred dependency relationship based on the asymmetry of the conditional probabilities:
   If CP(Eᵢ|Eⱼ) is high and CP(Eⱼ|Eᵢ) is low, infer a directed dependency: Eᵢ depends on Eⱼ.
   If CP(Eⱼ|Eᵢ) is high and CP(Eᵢ|Eⱼ) is low, infer the reverse directed dependency: Eⱼ depends on Eᵢ.
   If both are high, infer a strong bidirectional association or tight coupling between Eᵢ and Eⱼ.
   If both are low, no meaningful dependency relationship is inferred.
(6) Store the inferred dependency relationships as Structured Knowledge in the Knowledge Repository. Each inferred dependency is represented as a directed edge in the Knowledge Graph, annotated with its associated conditional probability values and support count. This annotation preserves the statistical basis of each inferred relationship, enabling downstream Agents and human reviewers to assess confidence and apply additional thresholds appropriate to their specific use cases.

The following pseudocode is an example algorithm for computing pairwise entity Co-occurrence and conditional dependency probabilities. The counts and probabilities computed may be stored in maps indexed by Entity pairs. The resulting conditional probabilities represent the statistical likelihood that one Entity is involved in an Incident given that another Entity is also involved and serve as a proxy for dependency relationships not explicitly documented in configuration or inventory systems.
Input:

Tickets=set of successfully remediated Tickets, including Corrected Tickets, each containing a list of involved Entities
Output:
   Co[Ei, Ej].—co-occurrence count of Entity pair (Ei, Ej)
   Ct[Ei]—marginal occurrence count of Entity Ei
   CP[Ei|Ej]—conditional probability of Ei given Ej
   CP[Ej|Ei]—conditional probability of Ej given Ei
Algorithm:
   1. Initialize:
      Co=empty map with default value 0
      Ct=empty map with default value 0
      CP=empty map with default value 0.0
   2. For each Ticket T in Tickets:
      Entities_T=set of all Entities referenced in T
      For each Entity Ei in Entities_T:
         Ct[Ei]=Ct[Ei]+1
      For each Entity Ej in Entities_T where Ej ≠Ei:
         Co[Ei, Ej]=Co[Ei, Ej]+1
   3. For each pair (Ei, Ej) appearing in Co:
      If Co[Ei, Ej]>=MinSupportThreshold:
         If Ct[Ej]>0:
         CP[Ei|Ej]=Co[Ei, Ej]/Ct[Ej]
      If Ct[Ei]>0:
         CP[Ej|Ei]=Co[Ei, Ej]/Ct[Ei]
   4. Return Maps Co, Ct, Cp

The dependency relationships mined by this algorithm complement those obtained from MELT data mining and from static configuration sources such as CMDBs. In particular, they capture dependencies that are behavioral in nature—revealed only through observed failure co-occurrence patterns—rather than those that are structurally defined. When integrated into the Knowledge Repository alongside topology and configuration data, these mined dependencies enrich the Knowledge Graph and improve the accuracy of downstream AIOps functions, including event correlation, root cause analysis, and impact assessment.

In some embodiments, because all dependency types (mined, inferred, and explicit) assert the same aiops:dependsOn traversal edge, a single Cypher or SPARQL query can retrieve the full dependency chain for any Entity without distinguishing provenance at query time. Thus, provenance detail is available when needed for explainability or confidence filtering, but does not complicate routine traversal. For example, the following SPARQL query retrieves all Entities that Application B depends on, regardless of how those dependencies were established:

```
SELECT ?dependency ?depType ?confidence ?verified
WHERE {
  aiops:AppB aiops:dependsOn+ ?dependency .
  OPTIONAL {
    ?rel aiops:dependentEntity aiops:AppB ;
    aiops:independentEntity ?dependency ;
    aiops:dependencyType ?depType ;
    aiops:confidenceLevel ?confidence ;
    aiops:is Verified ?verified .
  }
}
```

The + path operator performs transitive traversal, returning not just direct dependencies but the full k-hop dependency.

In operational contexts where only high-confidence mined dependencies should be used (e.g., during root cause analysis), the query can be filtered by provenance type and confidence level. For example, the following example SPARQL query filters results for specific provenance and probability level:

```
SELECT ?dependent ?independent ?prob
WHERE {
  ?rel a aiops: MinedDependency ;
    aiops: MinedDependency
    aiops:dependentEntity ?dependent ;
    aiops:independentEntity ?independent ;
    aiops:conditionalProbability ?prob ;
    aiops:confidenceLevel ″HIGH″ .
}
ORDER BY DESC(?prob)
```

In some embodiments, explicit dependencies are ingested into the Knowledge Repository via Transformers, as described previously. Each external source (e.g., CMDB, Network Inventory System, Service Directory, etc.) uses a dedicated Transformer that maps its native schema to the aiops:ExplicitDependency class and its associated properties. The Transformer asserts the corresponding aiops:dependsOn edge and creates a ProvenanceRecord linking the dependency to its source system.

Where the same dependency is asserted by both an explicit source and the mining algorithm, the Knowledge Repository may retain both assertions. This can enable the system to cross-validate mined dependencies against authoritative sources, and to flag mined dependencies that contradict explicit records for human review. Over time, as mined dependencies are verified by Subject Matter Experts and the aiops:isVerified flag is set to true, they may graduate to the same trust level as explicitly sourced dependencies, enriching the Knowledge Repository with behavioral dependency knowledge that no CMDB or inventory system could provide.

### Compounding Effect of Shared Knowledge: A Virtuous Cycle of Continuous Improvement

The preceding sections have described how individual components of the Knowledge-Augmented AIOps System may benefit from access to a shared Knowledge Repository. For example, the Correlation Agent may produce more accurate Incidents because it can traverse dependency relationships that would otherwise be invisible to it, the Root Cause Analysis Agent may reason more precisely because it operates over a semantically rich, unified model of the Monitored System rather than a fragmented collection of siloed data, and the Likely Fix Agent may recommend more effective remediations because it draws on statistically validated repair knowledge mined from historical Ticket data.

While each of these improvements is significant in its own right, the full significance of integration of the Knowledge Plane into the AIOps system cannot be appreciated by examining these improvements in isolation. Each improvement in Knowledge quality cascades forward through the pipeline, elevating the performance of every downstream component, and the outputs of those components feed back into the Knowledge Repository, further enriching it. The result is not a static system with fixed capabilities, but a continuously self-improving one. A virtuous cycle of learning and operational advancement.

For example, improved dependency Knowledge (whether mined from Ticket co-occurrence data, inferred from MELT data streams, or imported from authoritative external sources) can enable the Correlation Agent to group Entities into more accurate and complete Incidents. More accurate Incidents, in turn, produce higher-quality Trouble Tickets that correctly identify the true scope of affected Entities, reflect validated dependency relationships, and contain reliable Lead Symptom and Lead Entity data. Because these Tickets are more accurate, the co-occurrence patterns they encode are more meaningful, and the dependency relationships extracted during Knowledge Mining can be more reliable. These improved dependencies can be stored back into the Knowledge Repository, further improving the Correlation Agent's performance on the next cycle. Each revolution of this loop can yield incrementally better Knowledge, incrementally better correlation, and incrementally better Tickets. Thus, the described approach can provide compounding improvements that accelerate over time.

The same reinforcing dynamic operates across the full pipeline. Better Correlation produces better Incidents. Better Incidents enable more precise Root Cause Analysis. More precise Root Cause Analysis identifies the correct Lead Entity more consistently, which means the Likely Fix Agent is querying the Knowledge Repository with accurate inputs and returning higher-confidence remediation recommendations. Successful remediations, when recorded in closed Tickets, add further signal to the Ticket Mining algorithms, reinforcing the association between Symptoms, Entity Classes, and effective Fixes. The Knowledge Repository grows richer with every resolved Incident.

This is not incremental improvement at a single point in the pipeline. It is a flywheel: each component's improved output becomes another component's improved input, and the shared Knowledge Repository is the axle around which the entire system turns.

### Real-Time Knowledge-Based Correlation Algorithm

The goal of correlation is to group faults and anomalies that share a likely root cause into a single Incident. Accurate correlation enables reliable determination of root causes and fixes for IT and network issues. A real-time correlation algorithm driven by a Knowledge Graph can more accurately detect correlations and in particular uncover correlations not represented in existing databases that may otherwise be missed.

Real-time in this context means that the algorithm accepts streaming data performs either event-driven updates (e.g., recomputing on every new Signal) or updates in micro-batches (e.g., recomputing every few seconds). This stands in contrast to traditional decision support systems, which collect data over a fixed observation window, and produce results after the fact. Such systems cannot respond to conditions as they evolve and tend to be brittle against novel failure patterns. The algorithm described here can update groupings continuously as each new Signal arrives, with no fixed observation window.

The dependency relationships may be expressed as RDF triplets of the form [Entity, dependsOn, Entity] and [Signal, managedEntity, Entity], capturing persistent, operational, situational, and temporal dependencies within a single graph. By utilizing the Knowledge Graph, the algorithm benefits from the accumulated Knowledge captured by other knowledge acquisition tools, such as the mining tools for MELT data and Ticket data described elsewhere in this disclosure. However, the algorithm is not limited to Knowledge Graph sources. Only three queries are needed to drive the correlation, and these can readily be rewritten against relational databases, configuration management systems, or any other structured data source.

In one embodiment, the correlation algorithm maintains a working set of Incidents, called the Incident Knowledge Graph, which is initially empty. A companion Entity Index maps each observed Entity to the Incident that currently owns it. Each incoming Signal may be processed as follows:
Step 1: Identify the managed Entity. The System Knowledge Graph is queried for the Entity managed by the incoming Signal. This is the managed Entity and serves as the anchor point for all remaining steps.
Step 2: Attach the Signal to an Incident. The managed Entity is looked up in the Entity Index. If found, the Signal is added to the Incident that owns it. This becomes the current Incident. If not found, a new Incident is created, seeded with this Signal and its managed Entity, and registered in the Incident Knowledge Graph. This new Incident becomes the current Incident.
Step 3: Merge in Incidents from downstream neighbors. The set of all Entities that directly depend on the managed Entity is retrieved. Each entity is looked up in the Entity Index and if it belongs to an Incident other than the current one, that Incident is merged into the current Incident and retired.
Step 4: Merge in Incidents from upstream neighbors. The set of all Entities that the managed Entity directly depends on is retrieved. Each entity is looked up in the Entity Index and if it belongs to an Incident other than the current one, that Incident is merged into the current Incident and retired. If it was already absorbed during Step 3, the Entity Index will reflect this automatically and this is skipped.
Step 5: Record the merge and repeat. When an Incident is retired, it is not deleted. A pointer to the Incident that absorbed it is recorded within it, preserving the full merge lineage for later inspection. Control then returns to Step 1 to await the next incoming Signal.

The Incident Knowledge Graph can be highly dynamic. An Incident grows as new Signals arrive from within the impact zone of a root cause and stabilizes once all affected Entities have reported in. When a root cause is remediated and its Entities recover, the Incident is resolved and removed from the active set. Meanwhile, new Incidents are continuously created as new problems emerge. Incidents range from short-lived events affecting a handful of Entities to long-running events encompassing thousands or millions of Entities.

The following paragraphs provide a detailed view of an example embodiment of the correlation algorithm. It should be appreciated that other embodiments may include different or additional steps within the same general framework that has already been described.

The example embodiment of the correlation algorithm operates over two Knowledge Graphs (a System Knowledge Graph and an Incident Knowledge Graph) and one derived index. The System Knowledge Graph is a read-only graph containing all Signals, Entities, and the relationships between them. Two relationships can be used by the algorithm: a Signal manages exactly one Entity and an Entity may depend on zero or more other Entities. The Incident Knowledge Graph (IncidentKG)includes a working set of all Incidents, both active and retired and is initially empty. Retired Incidents are retained so that merge lineage can be recovered.

The correlation algorithm uses two other significant data structures: Incidents and an Entity Index. An Incident groups one or more Signals, and the Entities they manage, into a single correlated event. Example pseudocode for this operation is:
Incident
   id:unique identifier, assigned at creation
   signals:set of Signals belonging to this Incident
   entities:set of Entities belonging to this Incident
   mergedInto: Incident or null
      // Null->This Incident Is Still Active
      // non-null->this Incident has been retired;
      // follow mergedInto to find its successor

The Entity Index (entityIndex) is a map from EntityID to the Incident that currently contains that Entity. The Entity Index is updated whenever an Incident is created or two Incidents are merged:entityIndex: map of EntityID->Incident (initially empty)

In some embodiments, three read-only queries on SystemKG drive the algorithm. Example pseudocode for this operation is:
function getManagedEntity(s:SignalID)->EntityID
   // Returns the unique Entity managed by Signal s.
   return SystemKG.lookup(signal:s).managedEntity
function getDependsOn(e: EntityID)->set of EntityID
   // Returns all Entities that e directly depends on.
   return SystemKG.lookup(entity:e).dependsOn
function getDependents(e: EntityID)->set of EntityID
   // Returns all Entities that directly depend on e.
   // i.e., {d|e is in getDependsOn(d)}
   Return SystemKG.reverseedges(entity:e)

Using these data structures, various operations can be performed. A resolve operation takes advantage of the fact merges of Incidents can be chained (e.g., A merged into B, B merged into C) to walk the mergedInto links until it reaches the Incident that is still active. This is analogous to path resolution in a union-find structure. Example pseudocode for this operation is:
function resolve(I:Incident)->Incident
   while I.mergedInto is not null
      I<-I.mergedInto
   Return i

A findIncident operation looks up which active Incident currently contains Entity e and returns null if no Signal managing e has been seen yet. Example pseudocode for this operation is:
function findIncident(e:EntityID)->Incident or null
   I<-Entityindex[e]
   if I is null then return null
   //Follow any merge chain to the current live Incident.
   //This handles the case where the Incident originally
   //associated with e has since been subsumed by a larger one.
   return resolve(I)

A mergeInto operation absorbs the source Incident into the target Incident. All Signals and Entities from the source Incident are added to the target Incident. Source is retired by setting its mergedInto link to target, preserving the lineage for later inspection. Example pseudocode for this operation is:

```
function mergeInto(target : Incident, source : Incident)
  // Move all signals and entities from source into target.
  target.signals.addAll(source.signals)
  target.entities.addAll(source.entities)
  // Repoint the entity index so that future lookups on former
  // source members resolve directly to target.
  for each e in source.entities
    entityIndex[e] <- target
  // Retire source, recording where its contents went.
  source.mergedInto <- target
```

The main loop of the correlation algorithm can run continuously, processing each incoming Signal as it arrives. In one embodiment, the main loop carries out three steps for each Signal. Step 1: Attach the Signal to an Incident via its managed Entity. Step 2: Merge in any Incident whose Entity directly depends on the managed Entity (downstream neighbors). Step 3: Merge in any Incident whose Entity the managed Entity directly depends on (upstream neighbors). After processing, all Signals whose managed Entities are adjacent in the dependency graph reside in the same Incident. Example pseudocode for the main loop is:

```
loop forever
  S <- next incoming Signal
  E <- getManagedEntity(S)  // look up E in SystemKG
  // —— Step 1: Attach S to an Incident ————————————————
  I <- findIncident(E)
  if I is null then
    // E has not been seen before. Start a new Incident.
    I <- new Incident with
      id = generateID( )
      signals = { S }
      entities = { E }
      mergedInto = null
    IncidentKG.add(I)
    entityIndex[E] <- I
  else
    // E already belongs to an active Incident. Add S to it.
    I.signals.add(S)
    I.entities.add(E)
  // I is now the accumulating Incident for this Signal.
  // —— Step 2: Merge in Incidents from downstream neighbors ——————
  // A downstream neighbor D is an Entity that depends on E.
  // If D already belongs to a different Incident J, then J and I
  // are correlated and must be combined.
  for each D in getDependents(E) // { D | D dependsOn E } from SystemKG
    J <- findIncident(D)
    if J is not null and J != I then
      mergeInto(I, J)
  // —— Step 3: Merge in Incidents from upstream neighbors ——————
  // An upstream neighbor F is an Entity that E depends on.
  // If F already belongs to a different Incident J, then J and I
  // are correlated and must be combined.
  // Note: findIncident resolves through any merge chains, so if J
  // was already absorbed into I during Step 2, it will not be
  // merged a second time.
  for each F in getDependsOn(E) // { F | E dependsOn F } from SystemKG
    J <- findIncident(F)
    if J is not null and J != I then
      mergeInto(I, J)
  // S is now fully correlated. I contains all Signals whose managed
  // Entities are connected to E in the dependency graph.
end loop
```

In some embodiments, the following invariants hold after every Signal has been fully processed:
I1 Index consistency. The Entity Index and the Incident Knowledge Graph are always in sync: an Entity maps to an Incident in the index if and only if that Entity is a member of that Incident.
I2 Disjoint partition. No Entity belongs to more than one active Incident at any time. The active Incidents form a disjoint partition of all Entities observed so far.
I3 Live index reads. The Entity Index always reflects the latest merge state. Steps 3 and 4 therefore see the effect of any merges already performed within the same Signal's processing cycle, which ensures that a retired Incident surfacing in both steps is never merged a second time.
I4 No empty Incidents. Every Incident in the Incident Knowledge Graph contains at least one Signal. No empty or ghost Incidents are ever created.

In some embodiments, the correlation algorithm includes explicit mechanisms to address one or more of the following edge cases.

Case A: Signal arrives for an Entity already in an Incident. In this case, step 1 attaches the Entity while Steps 2 and 3 find no new neighbors, so the signal is added to the existing Incident. No merge is needed.

Case B: Two previously separate Incidents share a neighbor. The mergeInto function retires one and the J!=I guard prevents a self-merge if the same Incident surfaces in both Step 2 and Step 3.

Case C: A Dependency chain exists with an unmonitored intermediate Entity. The getDependents/getDependsOn functions return the Entity regardless of whether it has a Signal and the findIncident function returns null if the Entity has no Signal and therefore no Incident is recorded. The chain deliberately does not propagate across unmonitored Entities.

Case D: Concurrent or duplicate Signals are received for the same Entity. Both Signals land in the same Incident via Step 1. No merge is triggered because findIncident returns I itself, and the J!=I guard blocks a self-merge.

### Worked Examples

The following worked examples illustrate specific capabilities of various embodiments of the disclosed AIOps system and method. It should be appreciated that not all embodiments are capable of performing all of the worked examples or may perform similar tasks to the worked examples in different manners.

### Root Cause Analysis

Structured Knowledge stored in the Knowledge Repository can be used to triage and identify the root cause of a problem affecting an application (referred to as Application B), which is executing on a Kubernetes cluster in a large data center. The scenario is as follows:
Applications A and B are deployed on a Kubernetes cluster of servers.
Application B invokes the services of Application A.
Application A consists of one Pod P running on a server in a Kubernetes Cluster.
Pod P consists of several Containers, including Container C.
Container C has a memory leak, a “bug”, which causes it to crash.
Although Kubernetes automatically restarts C, its memory leak remains, and it continues to crash repeatedly. This impairs the Pod, and hence, the services provided by A.

Consider that the Knowledge Repository contains the following information:
The topological information mined from MELT data, and specifically,
   Container C is contained in Pod P
   Pod P Provides Service S
   Service S Is Offered by Application a
The logical service-to-application mapping from the Service Directory, which includes
   Application B uses Service S

The AIOps system is continuously monitoring the system, and through the real-time MELT data detects the following faults:
Application B is experiencing repetitive failures when invoking Service S
Container C is repetitively crashing.

The above two faults are among thousands of faults that the AIOps System is concurrently detecting in the data center. Therefore, among the noise of thousands of faults, it is not immediately obvious to either a human or Agent that the two faults are related. However, based on the Knowledge in the Knowledge Repository, the AIOps System is able to perform the following chain of reasoning based on known dependencies (denoted by “→”):
Application B→Service S→Pod P→Container C→has crashed

Alternatively, the Agent could reason based on “impact” which is the inverse of “dependency”, that is, “X depends on Y” implies “Y impacts X”.

Hence, the service invocation failures of Application B can be correlated with Container C's crashes, which is the root cause of B's service impacts.

The “chain of reasoning” illustrated in the preceding example is made possible by the novel capabilities introduced in this disclosure. Specifically, the combined functionality of the Knowledge Plane and a Knowledge-Augmented AIOps System enables:
Automated knowledge mining of MELT data to extract and organize critical insights into the Knowledge Repository.
The use of Transformers to convert and ingest “knowledge” from traditional sources—such as a Service Directory—into Structured Knowledge that is storable in Knowledge Repository.
Semantic integration of Knowledge from multiple heterogeneous sources.
Unification and abstraction of Knowledge, making it accessible and reusable across a wide range of Components (e.g., AIOps Agents), regardless of origin.
The deployment of Knowledge-Augmented AIOps Components, including Correlation and Root Cause Analysis Agents, that are capable of consuming and reasoning over Structured Knowledge.

As demonstrated in this example, these capabilities can deliver the following benefits:
Automated identification of the root cause—a memory failure in Container C of Application A.
Causal linkage between backend faults and the impact on Application B.
Contextualized explanations of the “chain of reasoning” from service layers anomalies back to infrastructure failures, enhancing transparency and traceability.
Optional automated remediation, such as the automated roll-back to a previous, stable version of Container C.
Reduction in mean time to detection, analysis, and resolution, resulting in improved service availability.
Improved operational efficiency through intelligent automation.
Substantive progress toward the goal of autonomous operations and self-healing systems.

### Storing Remediation Knowledge Mined From Trouble Ticket in a Knowledge Graph

Storing remediation knowledge as a Knowledge Graph can enable the information to be accessible for use by other Knowledge-capable agents. Specifically, the remediation knowledge can be a ProbSuccesSCF map in which entries have the form ProbSuccessSCF[S, C, F]->Probability_of_Success, which can be represented as a first-class node in a Knowledge Graph that links a Symptom, an Entity Class, and a Fix to a corresponding probability of success.

The minimal structure needed to store the learned remediation knowledge is:

### Classes:

:Symptom
:EntityClass
:Fix
:FixSuccessRule
   Object properties:
:hasSymptom
:hasEntityClass
:hasFix
   Datatype properties:
:hasProbability—the value from ProbSuccessSCF[S, C, F] map
:hasSupportCount—the value from CountSCF[S, C, F] map
:map:hasSuccessCount—the value from SuccessCountSCF[S, C, F] map

The RDF to express this structure (in Turtle) is:
@prefix: <http://example. com/fixkg#>.
@prefix rdf: <http://www.w3.org/1999/02/22-rdf-syntax-ns#>.
@prefix rdfs: <http://www.w3.org/2000/01/rdf-schema#>.
@prefix xsd:<http://www.w3.org/2001/XMLSchema#>.
:Symptom a rdfs:Class.
:EntityClass a rdfs:Class.
:Fix a rdfs:Class.
:FixSuccessRule a rdfs:Class.
:hasSymptom a rdf:Property;
   rdfs:domain :FixSuccessRule;
   rdfs:range :Symptom.
:hasEntityClass a rdf:Property;
rdfs:domain: FixSuccessRule;
rdfs:range: EntityClass.
:hasFix a rdf:Property;
   rdfs:domain :FixSuccessRule;
   rdfs:range :Fix.
:hasProbability a rdf:Property;
   rdfs:domain :FixSuccessRule;
   rdfs:range xsd:decimal.
:hasSupportCount a rdf:Property;
   rdfs:domain: FixSuccessRule;
   rdfs:range xsd:integer.
:hasSuccessCount a rdf:Property;
   rdfs:domain: FixSuccessRules;
   rdgs:range xsd:Integer.

The next step is to express a small sample of a ProbSuccesSCF map as a Knowledge Graphs. A sample contains 3 entries:
For Symptom LinkFlap and Entity Class RouterInterface, the Fix ResetInterface has probability 0.80
For the same Symptom and Entity Class, the Fix ReplaceTransceiver has probability 0.40
For Symptom HighCPU and Entity Class Router, the Fix RestartProcess has probability 0.75

Each sample entry can be expressed as an RDF Object and labeled with a “Rule#”:
#Symptoms used in the sample
   :LinkFlap a: Symptom.
   :HighCPU a: Symptom.
#Entity Classes used in the sample
   :RouterInterface a: EntityClass.
   :Router a: EntityClass.
#Fixes used in the sample
   :ResetInterface a: Fix.
   :ReplaceTransceiver a: Fix.
   :RestartProcess a: Fix.
#The sample map with each entry labels as a “Rule” Field
   :Rule1 a: FixSuccessRule;
      :hasSymptom: LinkFlap;
      :hasEntityClass: RouterInterface;
      :hasFix: ResetInterface;
      :hasProbability “0.80”\hat{ }\hat{ }xsd:decimal;
      :hasSupportCount “10”\hat{ }\hat{ }xsd:integer;
      :hasSuccessCount “8”\hat{ }\hat{ }xsd:integer.
   :Rule2 a: FixSuccessRule;
      :hasSymptom: LinkFlap;
      :hasEntityClass: RouterInterface;
      :hasFix: ReplaceTransceiver;
      :hasProbability “0.40”\hat{ }\hat{ }xsd:decimal;
      :hasSupportCount “5”\hat{ }\hat{ }xsd:integer;
      :hasSuccessCount “2”\hat{ }\hat{ }xsd:integer.
   :Rule3 a: FixSuccessRule;
      :hasSymptom :HighCPU;
      :hasEntityClass :Router;
      :hasFix: RestartProcess;
      :hasProbability “0.75”\hat{ }\hat{ }xsd:decimal;
      :hasSupportCount “12”\hat{ }\hat{ }xsd:integer;
      :hasSuccessCount “9”\hat{ }\hat{ }xsd:integer.

Storing Dependency Knowledge Fused from mining MELT data, mining Trouble Tickets, and integrating Explicit Dependencies from known sources

In one embodiment, the ontology for storing dependency knowledge accommodates three distinct provenance types: dependencies mined from Ticket co-occurrence data, dependencies inferred from MELT data, and dependencies explicitly sourced from authoritative systems such as CMDBs and Network Inventory Systems. The ontology captures the directional and probabilistic nature of mined dependencies, while representing explicit dependencies with full fidelity to their source. The ontology is defined using RDF Schema (RDFS) and OWL, and is organized around three core abstraction layers: Entities, Dependency Relationships, and Provenance Records.

The following classes may be included in the ontology:
aiops:Entity—the base class for all managed components in the Monitored System. Subclasses include aiops:Host, aiops:Router, aiops:Switch, aiops:Service, aiops:Pod, aiops:Container, aiops:VirtualMachine, and aiops:Application, among others. Each Entity instance carries properties for its unique identifier, its Class, and its human-readable name.
aiops:DependencyRelationship—the base class representing a directed dependency between two Entities. A dependency from Entity A to Entity B asserts that A depends on B, and hence that a failure in B may impact A. Subclasses distinguish dependency by provenance:
   aiops:MinedDependency—a dependency inferred statistically from Ticket co-occurrence data, carrying confidence metrics.
   aiops:InferredDependency—a dependency inferred from MELT data co-occurrence patterns, as described in the MELT mining algorithm.
   aiops:ExplicitDependency—a dependency sourced directly from an authoritative external system such as a CMDB, Network Inventory System, or Service Directory.
   aiops:ProvenanceRecord—a record capturing the origin, timestamp, and authority of a given dependency assertion. Each DependencyRelationship instance is linked to exactly one ProvenanceRecord.
   aiops:Ticket—represents a Trouble Ticket—including corrected Tickets, from which mined dependencies are derived.
   aiops:ExternalSource—represents an external authoritative data source, such as a CMDB or Network Inventory System, from which explicit dependencies are imported. Subclasses include aiops:CMDB, aiops:NetworkInventory, and aiops:ServiceDirectory.

The following object and datatype properties may define the structure of the dependency graph:
aiops:dependsOn—a directed object property from a dependent Entity to the Entity it depends on. Domain: aiops:Entity. Range: aiops:Entity. This is the primary relationship used for graph traversal and reasoning.
aiops:hasDependency—links an Entity to a DependencyRelationship instance that provides full detail on the dependency, including provenance and confidence.
aiops:dependentEntity—the Entity that depends on another. Domain: aiops:DependencyRelationship. Range: aiops:Entity.
aiops:independentEntity—the Entity that is depended upon. Domain: aiops:DependencyRelationship. Range: aiops:Entity.
aiops:conditionalProbability—for MinedDependency instances, the conditional probability CP(Eᵢ|Eⱼ) computed by the mining algorithm. Datatype: xsd:decimal.
aiops:coOccurrenceCount—the raw co-occurrence count supporting the mined dependency. Datatype: xsd:integer.
aiops:supportCount—the marginal occurrence count of the independent Entity, used as the denominator in the conditional probability computation. Datatype: xsd:integer.
aiops:confidenceLevel—a categorical confidence classification derived from the conditional probability value: HIGH, MEDIUM, or LOW. Datatype: xsd:string.
aiops:hasProvenance—links a DependencyRelationship to its ProvenanceRecord.
aiops:sourceSystem—links a ProvenanceRecord or ExplicitDependency to the ExternalSource from which it originates.
aiops:assertedBy—identifies the asserting agent, which may be the mining algorithm, an inference engine, or a human Subject Matter Expert.
aiops:assertedAt—timestamp of the dependency assertion. Datatype: xsd:dateTime.
aiops:isVerified—a boolean flag indicating whether a human Subject Matter Expert has verified the dependency. Datatype: xsd:boolean.
aiops:dependencyType—classifies the semantic nature of the dependency:

### Topological, Service, Containment, Power, Logical, or Unknown.

Datatype: xsd:string.

The following RDF Turtle fragment illustrates a mined dependency between two Entities derived from Ticket co-occurrence data:
@prefix aiops:<http://vitria.com/ontologies/aiops#>.
@prefix xsd:<http://www.w3.org/2001/XMLSchema#>.
#Entity instances
   aiops:AppB a aiops:Application;
      aiops:entityID “app-b-001”;
      aiops:name “Application B”.
   aiops:ServiceS a aiops:Service;
      aiops:entityID “svc-s-001”;
      aiops:name “Service S”.
#Mined dependency: Application B depends on Service S
   aiops:dep_AppB_ServiceS a aiops:MinedDependency;
      aiops:dependentEntity aiops:AppB;
      aiops:independentEntity aiops:ServiceS;
      aiops:conditionalProbability “0.87”\hat{ }\hat{ }xsd:decimal;
      aiops:coOccurrenceCount “43”\hat{ }\hat{ }xsd:integer;
      aiops:supportCount “49”\hat{ }\hat{ }xsd:integer;
      aiops:confidenceLevel “HIGH”;
      aiops:dependencyType “SERVICE”;
      aiops:isVerified “false”\hat{ }\hat{ }xsd:boolean;
      aiops:hasProvenance aiops:prov_dep_AppB_ServiceS.
#Shorthand traversal edge (also asserted for efficient graph queries)
   aiops:AppB aiops:dependsOn aiops:ServiceS.
#Provenance
   aiops:prov_dep_AppB_ServiceS a aiops:ProvenanceRecord;
      aiops:assertedBy “TicketMiningAlgorithm-v1.2”;
      aiops:assertedAt “2025-03-01T04: 00:00Z”\hat{ }\hat{ }xsd:dateTime;
      aiops:Sourcesystem Aiops: Ticketstore_dc1.

The following fragment illustrates an explicit dependency imported from a CMDB via a Transformer. Note that the same aiops:dependsOn traversal edge is asserted, enabling uniform graph queries regardless of provenance:
#Entity instances
   aiops:PodP a aiops:Pod;
      aiops:entityID “pod-p-001”;
      aiops:name “Pod P”.
      aiops:NodeN a aiops:Host;
      aiops:entityID “node-n-001”;
      aiops:name “Node N”.
#Explicit dependency: Pod P runs on Node N (sourced from CMDB)
   aiops:dep_PodP_NodeN a aiops:ExplicitDependency;
      aiops:dependentEntity aiops:PodP;
      aiops:independentEntity aiops:NodeN;
      aiops:dependencyType “CONTAINMENT”;
      aiops:isVerified “true”\hat{ }\hat{ }xsd:boolean;
      aiops:hasProvenance aiops:prov_dep_PodP_NodeN.
#Shorthand traversal edge
   aiops:PodP aiops:dependsOn aiops:NodeN.
#Provenance
   aiops:prov_dep_PodP_NodeN a aiops:ProvenanceRecord;
      aiops:assertedBy “CMDBTransformer-v2.0”;
      aiops:assertedAt “2025-02-15T09:00:00Z”\hat{ }\hat{ }xsd:dateTime;
      aiops:sourceSystem aiops:CMDB_Primary.
   aiops:CMDB_Primary a aiops:CMDB;
      aiops:name “Primary CMDB”;
      aiops:uri “https://cmdb.ops.internal”.

### Computing System Architecture

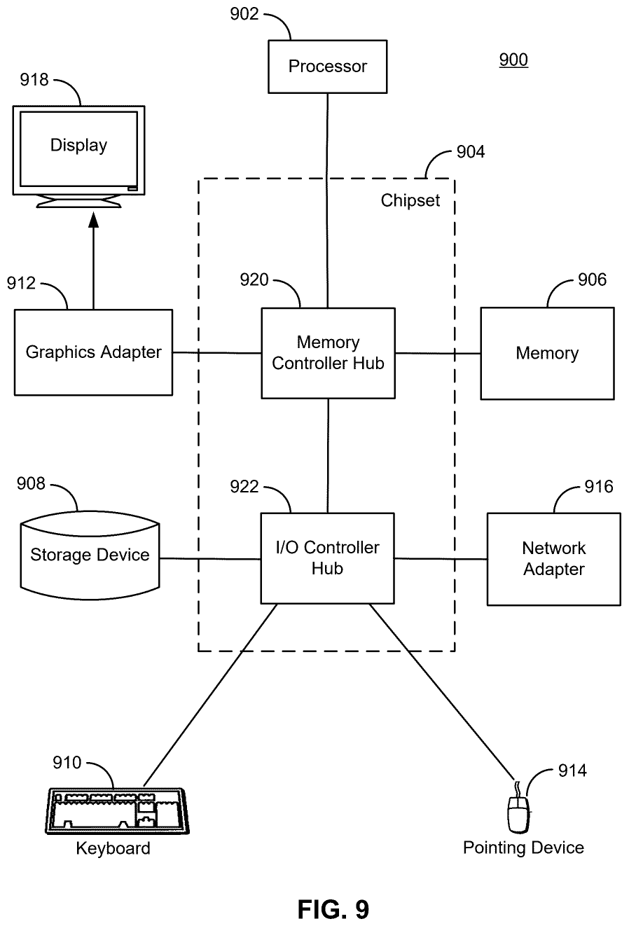

FIG. 9 is a block diagram of an example computer 900 suitable for use in the networked computing environment of FIG. 1. The example computer 900 includes at least one processor 902 coupled to a chipset 904. The chipset 904 includes a memory controller hub 920 and an input/output (I/O) controller hub 922. A memory 906 and a graphics adapter 912 are coupled to the memory controller hub 920, and a display 918 is coupled to the graphics adapter 912. A storage device 908, keyboard 910, pointing device 914, and network adapter 916 are coupled to the I/O controller hub 922. Other embodiments of the computer 900 have different architectures.

In the embodiment shown in FIG. 9, the storage device 908 is a non-transitory computer-readable storage medium such as a hard drive, compact disk read-only memory (CD-ROM), DVD, or a solid-state memory device. The memory 906 holds instructions and data used by the processor 902. The pointing device 914 is a mouse, track ball, touchscreen, or other type of pointing device, and may be used in combination with the keyboard 910 (which may be an on-screen keyboard) to input data into the computer system 900. The graphics adapter 912 displays images and other information on the display 918. The network adapter 916 couples the computer system 900 to one or more computer networks, such as network 170.

The types of computers used by the entities of FIG. 1 can vary depending upon the embodiment and the processing power required by the entity. For example, the AIOps system 110 might include multiple blade servers working together to provide the functionality described. Furthermore, the computers can lack some of the components described above, such as keyboards 910, graphics adapters 912, and displays 918.

### Additional Considerations

The systems and methods disclosed provide a unified and extensible framework for enhancing AIOps platforms through the integration of Structured Knowledge derived from diverse and heterogeneous data sources. This can enable the construction, maintenance, and utilization of Structured Knowledge within an AIOps system to significantly improve the accuracy, precision, and contextual relevance of core operational functions such as anomaly detection, root cause analysis, and automated remediation. These improvements can contribute directly to higher service assurance, greater operational efficiency, and reduced total cost of ownership.

The architecture further supports the seamless coexistence of both Knowledge-aware and legacy components through the use of Transformers and the Knowledge Plane, enabling progressive adoption of the techniques disclosed herein, while yielding commensurate progressive advancement toward the long-standing goal of fully Autonomous Operations and Self-Healing Systems.

Taken together, these components constitute a fundamentally new class of AIOps architecture. Conventional AIOps systems treat each pipeline stage as an independent function that is trained and operated in isolation, with no mechanism for sharing learned insights across components. The knowledge each component acquires (whether through ML model weights, rule sets, or statistical patterns) is encapsulated within that component and inaccessible to the rest of the system. When that component is retrained or replaced, its accumulated learning is lost. There is no shared substrate through which the system as a whole can improve.

The disclosed AIOps system breaks this pattern entirely. By introducing a shared, semantically structured, continuously updated Knowledge Repository that is accessible to all Agents, updated by all Agents, and governed by the Knowledge Plane, the AIOps system enables a qualitatively different mode of operation. Learning is no longer siloed. Improvements are no longer local. Every incremental advance in Knowledge quality is immediately available to every component in the system, and every component's improved outputs contribute back to the shared asset.

Some portions of the above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

What is claimed is:

1. A knowledge-augmented Artificial Intelligence for IT and Network Operations (AIOps) system comprising:
a knowledge plane including a structured knowledge data object stored on one or more non-transitory computer-readable media; and
a plurality of AI Agents for evaluating devices in a Monitored System, wherein at least some of the plurality of AI Agents share access to the structured knowledge data object via the knowledge plane.

2. The knowledge-augmented AIOps system of claim 1, wherein the knowledge plane comprises:
a knowledge service providing an API layer for querying and updating the structured knowledge data object; and
knowledge mining tools for extracting structured knowledge from operational data.

3. The knowledge-augmented AIOps system of claim 1, wherein the structured knowledge data object comprises:
topology information describing interconnections between components in the Monitored System;
dependency relationships among system components; and
diagnostic knowledge including symptoms and remediation information.

4. The knowledge-augmented AIOps system of claim 1, wherein the plurality of AI Agents comprises:
a correlation agent configured to group faults and anomalies into incidents based on the structured knowledge data object;
a root cause analysis agent configured to identify probable root causes using dependency relationships from the structured knowledge data object; and
a likely fix agent configured to recommend remediation actions based on historical remediation knowledge stored in the structured knowledge data object.

5. The knowledge-augmented AIOps system of claim 1, further comprising:
transformers configured to convert data between different representational formats for integration with the knowledge plane.

6. The knowledge-augmented AIOps system of claim 1, wherein the system further comprises one or more transformers configured to ingest metrics, events, logs, and traces (MELT) data from the Monitored System, and one or more of the plurality of AI Agents are configured to:
mine entity relationships from the MELT data by analyzing co-occurrence patterns of entity identifiers; and
store the mined entity relationships in the structured knowledge data object.

7. The knowledge-augmented AIOps system of claim 6, wherein mining entity relationships comprises:
identifying fields with highest cardinality as primary keys for monitored entities;
treating fields referencing other entities as foreign keys; and
inferring relationships based on co-occurrence of primary keys and foreign keys within data records.

8. The knowledge-augmented AIOps system of claim 1, wherein one or more of the plurality of AI agents are configured to:
collect trouble tickets associated with resolved incidents;
analyze co-occurrence patterns of entities within the trouble tickets; and
infer dependency relationships between entities based on conditional probabilities derived from the co-occurrence patterns.

9. The knowledge-augmented AIOps system of claim 8, wherein the one or more of the plurality of AI agents are further configured to:
compute conditional probabilities for entity pairs appearing in trouble tickets;
classify dependency relationships based on asymmetry of the conditional probabilities; and
store the inferred dependency relationships in the structured knowledge data object with associated confidence metrics.

10. The knowledge-augmented AIOps system of claim 1, wherein one or more of the plurality of AI Agents are configured to:
extract remediation knowledge from trouble tickets by analyzing relationships between symptoms, entity classes, and applied fixes;
compute success probabilities for fix recommendations based on historical outcomes; and
store the remediation knowledge in the structured knowledge data object for use by the likely fix agent.

11. A method for knowledge-augmented artificial intelligence operations comprising:
maintaining a knowledge plane including a structured knowledge data object containing operational knowledge about a monitored system;
providing a plurality of AI agents access to the structured knowledge data object via the knowledge plane;
ingesting operational data from devices in the monitored system;
processing the operational data using the plurality of AI agents, wherein the AI agents utilize the structured knowledge data object to improve accuracy of operational functions; and
updating the structured knowledge data object based on outputs from the plurality of AI agents.

12. The method of claim 11, further comprising:
mining entity relationships from metrics, events, logs, and traces data by identifying co-occurrence patterns of entity identifiers;
extracting dependency relationships from trouble ticket co-occurrence data; and
deriving remediation knowledge from historical trouble ticket outcomes.

13. The method of claim 11, wherein processing the operational data comprises:
correlating faults and anomalies into incidents using dependency relationships from the structured knowledge data object;
performing root cause analysis by traversing dependency chains in the structured knowledge data object; and
recommending fixes based on remediation knowledge stored in the structured knowledge data object.

14. The method of claim 11, further comprising:
converting data between different representational formats using transformers to enable integration of legacy systems with the knowledge plane.

15. The method of claim 11, further comprising:
collecting trouble tickets associated with resolved incidents;
analyzing co-occurrence patterns of entities within the trouble tickets;
inferring dependency relationships between entities based on conditional probabilities derived from the co-occurrence patterns;
computing conditional probabilities for entity pairs appearing in trouble tickets;
classifying dependency relationships based on asymmetry of the conditional probabilities; and
storing the inferred dependency relationships in the structured knowledge data object with associated confidence metrics.

16. One or more non-transitory computer-readable storage media storing instructions that, when executed by one or more processors, cause a computing system to perform operations comprising:
maintaining a knowledge plane including a structured knowledge data object containing operational knowledge about a monitored system;
providing a plurality of AI agents access to the structured knowledge data object via the knowledge plane;
ingesting operational data from devices in the monitored system;
processing the operational data using the plurality of AI agents, wherein the AI agents utilize the structured knowledge data object to improve accuracy of operational functions; and
updating the structured knowledge data object based on outputs from the plurality of AI agents.

17. The one or more non-transitory computer-readable storage media of claim 16, wherein the operations further comprise:
mining entity relationships from metrics, events, logs, and traces data by identifying co-occurrence patterns of entity identifiers;
extracting dependency relationships from trouble ticket co-occurrence data; and
deriving remediation knowledge from historical trouble ticket outcomes.

18. The one or more non-transitory computer-readable storage media of claim 16, wherein processing the operational data comprises:
correlating faults and anomalies into incidents using dependency relationships from the structured knowledge data object;
performing root cause analysis by traversing dependency chains in the structured knowledge data object; and
recommending fixes based on remediation knowledge stored in the structured knowledge data object.

19. The one or more non-transitory computer-readable storage media of claim 16, wherein the operations further comprise:
converting data between different representational formats using transformers to enable integration of legacy systems with the knowledge plane.

20. The one or more non-transitory computer-readable storage media of claim 16, wherein the operations further comprise:
collecting trouble tickets associated with resolved incidents;
analyzing co-occurrence patterns of entities within the trouble tickets;
inferring dependency relationships between entities based on conditional probabilities derived from the co-occurrence patterns;
computing conditional probabilities for entity pairs appearing in trouble tickets;
classifying dependency relationships based on asymmetry of the conditional probabilities; and
storing the inferred dependency relationships in the structured knowledge data object with associated confidence metrics.
